(19) United States
(12) Patent Application Publication
(10) Pub. No.: US 2025/0374161 A1
(43) Pub. Date: Dec. 4, 2025

(54) MULTI-PATH PROCESSING METHOD AND APPARATUS

(71) Applicant: FUJITSU LIMITED, Kawasaki-shi (JP)

(72) Inventors: Guorong LI, Beijing (CN); Su YI, Beijing (CN); Meiyi JIA, Beijing (CN); Xin WANG, Beijing (CN)

(73) Assignee: FUJITSU LIMITED, Kawasaki-shi (JP)

(21) Appl. No.: 19/299,613

(22) Filed: Aug. 14, 2025

Related U.S. Application Data
(63) Continuation of application No. PCT/CN2023/076161, filed on Feb. 15, 2023.

(51) Int. Cl. H04W 40/12; H04W 40/22

(52) U.S. Cl. CPC H04W 40/12; H04W 40/22

(57) ABSTRACT

A multi-path processing apparatus, configured in a remote terminal equipment, includes: a receiver configured to receive indication information transmitted by a network device; and a transmitter configured to transmit data by using a direct path or an indirect path in the multi-path according to the indication information, wherein the indication information comprises a first threshold related to a data amount of a PDCP (packet data convergence protocol) layer.

### CROSS-REFERENCE TO RELATED APPLICATION

This application is a continuation application under 35 U.S.C. 111(a) of International Patent Application PCT/CN2023/076161 filed on Feb. 15, 2023, and designated the U.S., the entire contents of which are incorporated herein by reference.

### FIELD

This disclosure relates to the field of communication.

### BACKGROUND

In Release 17 of 3GPP, sidelink relay (SL relay) was studied, which includes a scenario of UE-to-Network relay. In this scenario, a remote UE communicates with a network device via a relay UE, wherein NR Uu is used on a Uu link of the relay user equipment, and an NR sidelink is used on a PC5 interface between the remote UE and the relay UE. In the scenario of UE-to-Network relay, the relay UE is also referred to as a UE-to-Network relay UE.

In Release 18, a scheme supporting multi-path will be studied. A scenario of multi-path may be: a remote terminal equipment is connected to a network device (e.g. gNB) by using a direct path and an indirect path. For example, the direct path may be that the remote terminal equipment is connected directly to the network device via a Uu interface, and the indirect path may be that the remote terminal equipment is connected to the network device via a layer-2 (L2) UE-to-network relay.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

It was found by the inventors that in some multi-path scenarios, path switch is unable to be efficiently and reasonably achieved, QoS of services are unable to be satisfied, and utilization rates of wireless resources are low.

In order to solve at least one of the above problems, embodiments of this disclosure provide a multi-path processing method and apparatus.

According to one aspect of the embodiments of this disclosure, there is provided a multi-path processing apparatus, configured in a remote terminal equipment, the apparatus including: a receiving unit configured to receive indication information transmitted by a network device; and a transmitting unit configured to transmit data by using a direct path and/or an indirect path in the multi-path according to the indication information.

According to another aspect of the embodiments of this disclosure, there is provided a multi-path processing method, applicable to a remote terminal equipment, the method including: receiving indication information transmitted by a network device; and transmitting data by using a direct path and/or an indirect path in the multi-path according to the indication information.

According to a further aspect of the embodiments of this disclosure, there is provided a multi-path processing apparatus, configured in a remote terminal equipment, the remote terminal equipment being configured or activated with a first path and a second path, and the apparatus including: a transmitting unit configured to transmit data by using the first path and/or second path according to remaining PDBs of sidelink data to be transmitted in a logical channel and/or the number of uplink grants or uplink resources of the first path and/or the number of SR transmissions of the first path and/or the number of times of expiration of a loss timer.

According to still another aspect of the embodiments of this disclosure, there is provided a multi-path processing method, applicable to a remote terminal equipment, the remote terminal equipment being configured or activated with a first path and a second path, and the method including: transmitting data by using the first path and/or second path according to remaining PDBs of sidelink data to be transmitted in a logical channel and/or the number of uplink grants or uplink resources of the first path and/or the number of SR transmissions of the first path and/or the number of times of expiration of a loss timer.

According to yet another aspect of the embodiments of this disclosure, there is provided a remote terminal equipment, including a memory and a processor, the memory storing a computer program, and the processor being configured to execute the computer program to carry out the multi-path processing method at the remote terminal equipment side described above.

According to yet still another aspect of the embodiments of this disclosure, there is provided a multi-path processing apparatus, configured in a network device, the apparatus including: a transmitting unit configured to transmit indication information to a terminal equipment, the indication information being used to indicate the terminal equipment to transmit data by using a direct path and/or an indirect path in the multi-path.

According to further still another aspect of the embodiments of this disclosure, there is provided a multi-path processing method, applicable to a network device, the method including: transmitting indication information to a terminal equipment, the indication information being used to indicate the terminal equipment to transmit data by using a direct path and/or an indirect path in the multi-path.

According to yet further still another aspect of the embodiments of this disclosure, there is provided a network device, including a memory and a processor, the memory storing a computer program, and the processor being configured to execute the computer program to carry out the multi-path processing method at the network device side described above.

One of the advantages of the embodiments of this disclosure exists in that the remote terminal equipment transmits data by using a direct path and/or an indirect path in the multi-path according to the indication information transmitted by the network device, or the remote terminal equipment transmits data by using the first path and/or second path according to remaining PDBs of sidelink data to be transmitted in a logical channel and/or the number of uplink grants or uplink resources of the first path and/or the number of SR transmissions of the first path and/or the number of times of expiration of a loss timer, which is helpful to the remote terminal equipment in efficiently and reasonably achieving path switch, and is advantageous to ensuring QoS of the services of the remote terminal equipment and improving utilization rates of network resources.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of a multi-path scenario of the embodiment of this disclosure;

FIG. 3 is a schematic diagram of a multi-path protocol stack structure of the embodiment of this disclosure;

FIG. 4 is a schematic diagram of a multi-path processing method of an embodiment of this disclosure;

FIG. 5 is a schematic diagram of a multi-path processing method of an embodiment of this disclosure;

FIG. 6 is a schematic diagram of a multi-path processing method of an embodiment of this disclosure;

FIG. 7 is a schematic diagram of a multi-path scenario of an embodiment of this disclosure;

FIG. 8 is another schematic diagram of the multi-path processing method of the embodiment of this disclosure;

FIG. 9 is a schematic diagram of a multi-path processing method of an embodiment of this disclosure;

FIG. 10 is another schematic diagram of the multi-path processing method of the embodiment of this disclosure;

FIG. 11 is a schematic diagram of a multi-path processing method of an embodiment of this disclosure;

FIG. 12 is a schematic diagram of a multi-path processing apparatus of an embodiment of this disclosure;

FIG. 13 is another schematic diagram of the multi-path processing apparatus of the embodiment of this disclosure;

FIG. 14 is a schematic diagram of a multi-path processing apparatus of an embodiment of this disclosure;

FIG. 15 is another schematic diagram of the multi-path processing apparatus of the embodiment of this disclosure;

FIG. 16 is a schematic diagram of a multi-path processing apparatus of an embodiment of this disclosure;

FIG. 17 is a schematic diagram of a multi-path processing apparatus of an embodiment of this disclosure;

FIG. 18 is another schematic diagram of the multi-path processing apparatus of the embodiment of this disclosure;

FIG. 19 is a schematic diagram of a structure of a terminal equipment of an embodiment of this disclosure; and

FIG. 20 is a schematic diagram of a structure of a network device of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment, except otherwise specified.

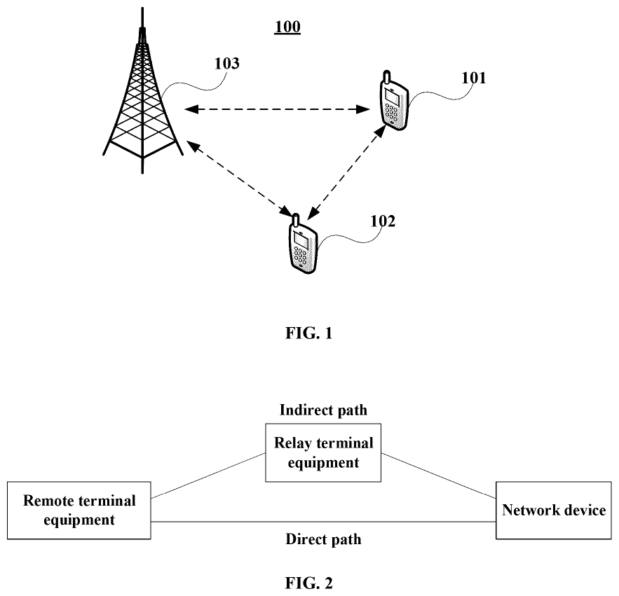

FIG. 1 is a schematic diagram of a communication system of an embodiment of this disclosure, illustrating a case taking a remote terminal equipment, a relay terminal equipment and a network device as an example. As shown in FIG. 1, the communication system 100 may include a remote terminal equipment 101, a relay terminal equipment 102 and a network device 103. The remote terminal equipment 101 is connected to the network device 103 via a direct path and an indirect path. For the sake of simplicity, description is given in FIG. 1 by taking two terminal equipments (one remote terminal equipment and one relay terminal equipment) and one network device as an example; however, the embodiment of this disclosure is not limited thereto.

In the embodiment of this disclosure, existing services or services that may be implemented in the future may be performed between the network device 103 and the remote terminal equipment 101 and the relay terminal equipment 102. For example, such services may include but not limited to an enhanced mobile broadband (eMBB), massive machine type communication (MTC), ultra-reliable and low-latency communication (URLLC), etc.

FIG. 2 is a schematic diagram of a multi-path scenario of the embodiment of this disclosure. As shown in FIG. 2, in the embodiment of this disclosure, the remote terminal equipment may communicate with a network device (such as a gNB) via a direct path and an indirect path simultaneously. For example, the remote terminal equipment may communicate with the network device via a Uu interface (a direct path) and communicate with the same network device via a relay terminal equipment (an indirect path).

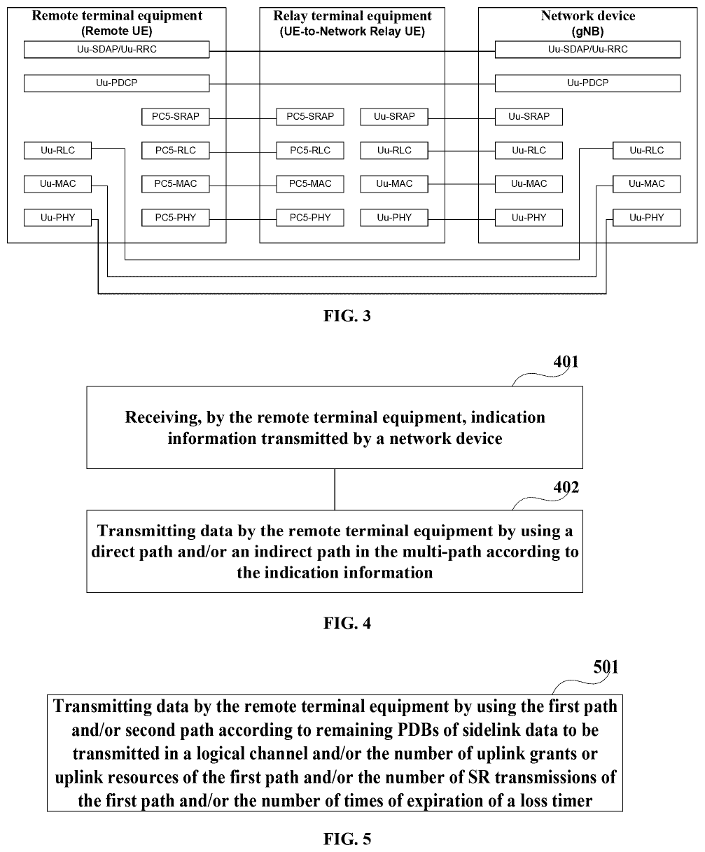

FIG. 3 is a schematic diagram of a multi-path protocol stack structure of the embodiment of this disclosure. As shown in FIG. 3, the direct path between the remote terminal equipment and the network device uses a Uu interface protocol stack, and the indirect path between the remote terminal equipment and the network device is transmitted via L2 UE-to-Network relay, using the PC5 interface and a Uu interface protocol stack.

In some embodiments, as shown in FIG. 3, an RRC (radio resource control) layer, a service data adaptation protocol (SDAP) layer and a packet data convergence protocol (PDCP) layer in the remote terminal equipment are equivalent to an RRC layer, an SDAP layer and a PDCP layer in the network device. Data of the PDCP layer of the remote terminal equipment may be transmitted to the network device via the indirect path passing the relay user equipment. For example, a PDCP PDU (protocol data unit) of the remote terminal equipment may be transmitted to the relay UE via a PC5-SRAP, a PC5-RLC, a PC5-MAC and a PC5-PHY through a sidelink, and then the relay UE transmits the data to a gNB via its own Uu interface protocol stack (a Uu SRAP, a Uu RLC, a Uu MAC, and a Uu PHY). The gNB side receives the data from a peer Uu interface protocol stack of the relay UE, and transmits the data to the Uu-PDCP of the gNB for processing. Or, data of the PDCP layer of the remote terminal equipment may be transmitted to the network device via a direct path. For example, the PDCP PDU of the remote terminal equipment may be transmitted to the gNB via a Uu RLC, a Uu MAC, and a Uu PHY. The gNB side receives the data from a peer Uu interface protocol stack of the remote UE, and transmits the data to the Uu-PDCP of the gNB for processing. In addition, in the direct path and/or the indirect path, there may be one or more RLC (radio link control) entities (Uu RLC entities or PC5 RLC entities) associated with a PDCP entity of a radio bearer.

In some embodiments, as shown in FIG. 3, in the protocol stack of the gNB side, one Uu MAC entity may be used to process data of the remote terminal equipment and the relay user equipment.

In some embodiments, as shown in FIG. 3, in the remote terminal equipment, one MAC entity may be used to perform PC5-MAC and Uu MAC operations.

In some embodiments, as shown in FIG. 3, transmitting via a direct path refers to, for example, that the PDCP layer transmits data to a Uu RLC bearer or channel or entity, and transmitting via an indirect path refers to, for example, that the PDCP layer transmits data to the SRAP (sidelink relay adaptation protocol) entity and then data is transmitted via the RLC bearer or channel or entity of PC5.

In some embodiments, the data may be PDCP SDUs (service data units) or PDCP PDUs or RLC SDUs, etc.

Various implementations of the embodiments of this disclosure shall be described below with reference to the accompanying drawings. These implementations are illustrative only, and are not intended to limit this disclosure.

### Embodiment of a First Aspect

The embodiment of this disclosure provides a multi-path processing method, applicable to a remote terminal equipment. FIG. 4 is a schematic diagram of the multi-path processing method of the embodiment of this disclosure. As shown in FIG. 4, the method includes:
401: receiving, by the remote terminal equipment, indication information transmitted by a network device; and
402: transmitting data by the remote terminal equipment by using a direct path and/or an indirect path in the multi-path according to the indication information.

It should be noted that FIG. 4 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

According to the above embodiment, the remote terminal equipment transmits data by using a direct path and/or an indirect path in the multi-path according to the indication information transmitted by the network device, which is helpful to the remote terminal equipment in efficiently and reasonably achieving path switch, and is advantageous to ensuring QoS (quality of service) of the services of the remote terminal equipment and improving utilization rates of network resources.

For example, the remote terminal equipment may offload services at congested direct connection (direct path) to indirect connection (indirect path) via the relay terminal equipment (relay UE) according to the indication information, which is helpful to the remote terminal equipment in efficiently and reasonably performing path switch.

In some embodiments, a directly connected cell and an indirectly connected cell may be different intra-frequency or inter-frequency cells.

For another example, when the remote terminal equipment transmits the data to the relay terminal equipment in a sidelink in mode 2, the remote terminal equipment may autonomously select sidelink resources. In this case, transmitting the indication information indicating the remote terminal equipment to perform path selection to the remote terminal equipment may be helpful to the remote terminal equipment in efficiently and reasonably performing path selection or switch.

In some embodiments, the indication information may include at least one of the following:
indication on offloading to a direct path or an indirect path;
payload information on a direct path and/or an indirect path;
a utilization rate(s) of a direct path and/or an indirect path;
a first threshold related to a data amount of a PDCP layer; or
a radio bearer or QoS flow using a direct path, and/or a radio bearer or QoS flow using an indirect path, and/or a radio bearer or QoS flow using a direct path and an indirect path.

In some embodiments, in a case where the indication information includes the indication on offloading to a direct path or an indirect path, the remote terminal equipment may transmit data of the PDCP layer (such as subsequent PDCP SDUs or PDCP PDUs or RLC SDUs, etc.) via the direct path or indirect path. For example, in a case where the remote terminal equipment receives the indication information including the indication on offloading to a direct path, subsequent PDCP layer data are transmitted via the indirect path. Therefore, even in the event of congestion on the direct path, uplink data may still be transmitted via the indirect path, thereby ensuring QoS of services.

In some embodiments, the payload information may indicate a payload level(s) and/or a payload proportion(s) of the direct path and/or the indirect path. For example, the payload level may include high, medium, and low levels, etc. For example, the payload proportion may refer to a percentage of traffic transmitted by using the direct path to a traffic that the direct path is able to carry, or a channel occupancy rate or a channel busy rate, and/or a percentage of traffic transmitted by using the indirect path to a traffic that the indirect path is able to carry, or a channel occupancy rate or a channel busy rate.

In some embodiments, the indication information may further include sidelink resource configuration information to which the payload information corresponds, for example, the configuration information may include at least one of the following: the number of times of HARQ retransmission, a frequency resource amount or a range of a frequency resource amount, and configuration of a sidelink resource pool (such as configuration of sidelink slot resources, etc.).

In some embodiments, in a case where the indication information includes the payload information,
when the payload of the direct path is indicated to be high or the payload proportion of the direct path exceeds a second threshold, the data are transmitted by using the indirect path; and/or
when the payload of the indirect path is indicated to be high or the payload proportion of the indirect path exceeds a third threshold, the data are transmitted by using the direct path; and/or
when the payload of the direct path is indicated to be low or the payload proportion of the direct path is lower than a fourth threshold, the data are transmitted by using the direct path; and/or
when the payload of the indirect path is indicated to be low or the payload proportion of the indirect path exceeds a fifth threshold, the data are transmitted by using the indirect path; and/or
when the payloads of both the direct path and the indirect path are indicated to be high or the payload proportions of the direct path and the indirect path exceed a sixth threshold and a seventh threshold respectively, the data are transmitted by using the direct path and/or the indirect path; and/or
when the payloads of both the direct path and the indirect path are indicated to be low or the payload proportions of the direct path and the indirect path are lower than an eighth threshold and a ninth threshold respectively, the data are transmitted by using the direct path and/or the indirect path; and/or
when the indication information includes the sidelink resource configuration information to which the payload information corresponds, the sidelink resource configuration information is used to perform sidelink resource selection.

Thus, the remote terminal equipment may reasonably and efficiently perform multi-path switch.

For example, when the payload of the direct path is indicated to be high or the payload proportion of the direct path exceeds the second threshold, it means that more data are transmitted by using the direct path, and the likelihood of congestion on the direct path is relatively high. In this case, using the indirect path to transmit uplink data is helpful to ensure QoS of services.

For another example, when the payload of the indirect path is indicated to be high or the payload proportion of the indirect path exceeds the third threshold, it means that more data are transmitted by using the indirect path, and the likelihood of congestion on the indirect path is relatively high. In this case, using the direct path to transmit uplink data is helpful to ensure QoS of services

For a further example, when the payload(s) of the direct path and/or indirect path is/are indicated to be low or payload percentage(s) of the direct path and/or indirect path is/are lower than a threshold, the remote terminal equipment may select or use one or more paths for data transmission according implementation of its own.

For still another example, when the payloads of the direct path and indirect path are indicated to be high or payload percentages of the direct path and indirect path exceed a threshold, the remote terminal equipment may transmit uplink data via the indirect path, so as to avoid congestion on the direct path.

In some embodiments, the utilization rate(s) indicate(s) a proportion of an amount of traffics transmitted via the direct path and/or the indirect path, and/or indicate(s) a ratio of amounts of traffics of the direct path and indirect path.

For example, the utilization rate(s) may indicate a proportion of traffic transmitted by using the direct path to a total amount of traffics, or a proportion of traffic transmitted by using the indirect path to a total amount of traffics, or a proportion of traffic transmitted by using the direct path to a total amount of traffics and a proportion of traffic transmitted by using the indirect path to a total amount of traffics. This rate is, for example, a percentage or a fraction.

For another example, the utilization rate(s) may indicate a ratio of traffic transmitted by using the direct path to traffic transmitted by using the indirect path. The ratio is, for example, an integer or a fraction.

In some embodiments, in the case where the indication information includes the utilization rate(s), the remote terminal equipment may transmit data of a corresponding amount of traffics in the direct path and/or indirect path according to the utilization rate(s). For example, in a case where the indication information indicates to transmit 70% of the traffic via the direct path and 30% of the traffic via the indirect path, the remote terminal equipment transmits 70% of subsequent PDCP layer data via the direct path and 30% of subsequent PDCP layer data via the indirect path.

In some embodiments, in a case where the indication information includes the first threshold,
when the data amount of the PDCP layer is greater than the first threshold, the remote terminal equipment may transmit the data by using the indirect path and/or the direct path; and/or
when the data amount of the PDCP layer is less than the first threshold, the remote terminal equipment may transmit the data by using the indirect path and/or the direct path.

For example, when the data amount of the PDCP layer (such as PDCP SDUs or PDCP PDUs) is greater than the first threshold, the remote terminal equipment may transmit by using the indirect path, or by using the direct path, or by using the direct path and the indirect path.

For another example, when the data amount of the PDCP layer is less than the first threshold, the remote terminal equipment may transmit the data by using the indirect path. When the data amount of the PDCP layer is greater than the first threshold, the remote terminal equipment may transmit the data by using the direct path. For example, a value of the first threshold may be relatively high, so that most of the data may be transmitted to the network device via the indirect path.

For a further example, when the data amount of the PDCP layer is less than the first threshold, the remote terminal equipment may transmit the data by using the indirect path and/or the direct path. When the data amount of the PDCP layer is greater than the first threshold, the remote terminal equipment may transmit the data by using the indirect path. For example, a value of the first threshold may be relatively low, so that most of the data may be transmitted to the network device via the indirect path, thereby avoiding congestion on the direct path.

In some embodiments, the radio bearer included in the indication information may be a signaling radio bearer (SRB) and/or a data radio bearer (DRB), wherein the SRB may include SRB1 and/or SRB2.

In some embodiments, the indication information includes a radio bearer or QoS flow using the direct path. For example, the indication information may indicate a DRB using the direct path (such as indicating by enumerating DRB IDs or using a DRB list) or a QoS flow (such as indicating by enumerating QoS flow IDs or using a QoS flow list), or may indicate a DRB ID or QoS flow ID to which a Uu RLC bearer corresponds; or, the indication information may indicate that a path to which a DRB or QoS flow corresponds is a direct path, or may indicate that an RLC bearer to which a DRB or QoS flow corresponds is a Uu RLC bearer, and it may additionally indicate other information, such as an identifier of a Uu RLC bearer.

In some embodiments, the indication information includes a radio bearer or QoS flow using the indirect path. For example, the indication information may indicate a DRB using the indirect path (such as indicating by enumerating DRB IDs or using a DRB list) or a QoS flow using the indirect path (such as indicating by enumerating QoS flow IDs or using a QoS flow list), or may indicate a DRB ID or QoS flow ID to which a PC5-RLC bearer corresponds; or, the indication information may indicate that a path to which a DRB or QoS flow corresponds is an indirect path, or may indicate that an RLC bearer to which a DRB or QoS flow corresponds is a PC5-RLC bearer, and it may additionally indicate other information, such as an identifier of a PC5-RLC bearer.

In some embodiments, the indication information includes a radio bearer or QoS flow using the indirect path and the indirect path. For example, the indication information may indicate a DRB using the indirect path and the indirect path (such as indicating by enumerating DRB IDs or using a DRB list) or a QoS flow using the indirect path and the indirect path (such as indicating by enumerating QoS flow IDs or using a QoS flow list), or may indicate that a Uu RLC bearer and a PC5-RLC bearer correspond to identical DRB IDs or QoS flow IDs; or, the indication information may indicate that paths to which a DRB or QoS flow corresponds are a direct path and an indirect path, or may indicate that an RLC bearer to which a DRB or QoS flow corresponds includes at least one Uu RLC bearer and at least one PC5-RLC bearer, and it may additionally indicate other information, such as an identifier of a Uu RLC bearer and/or an identifier of a PC5-RLC bearer.

In some embodiments, a DRB or a QoS flow may be configured as split transmission or duplication transmission. When it is configured as split transmission, different data of the PDCP layer are transmitted in the direct path and indirect path, or in the Uu RLC bearer and PC5-RLC bearer, and when it is configured as duplication transmission, identical data of the PDCP layer are transmitted in the direct path and indirect path, or in the Uu RLC bearer and PC5-RLC bearer.

In the above embodiment, the RLC bearer may also be expressed as an RLC channel or an RLC entity. For example, the Uu RLC bearer may also be expressed as a Uu RLC channel or a Uu RLC entity, and the PC5-RLC bearer may also be expressed as a PC5-RLC channel or a PC5 RLC entity.

In some embodiments, in the case where the indication information includes the radio bearer or QoS flow using the direct path, the remote terminal equipment may transmit data of the radio bearer or QoS flow by using the direct path.

In some embodiments, in the case where the indication information includes the radio bearer or QoS flow using the indirect path, the remote terminal equipment may transmit data of the radio bearer or QoS flow by using the indirect path.

In some embodiments, in the case where the indication information includes the radio bearer or QoS flow using the direct path and the indirect path, the remote terminal equipment may transmit data of the radio bearer or QoS flow using the direct path and the indirect path by using the direct path and the indirect path.

In some embodiments, one or more of the first threshold to the ninth threshold may be configured by a network or may be preset.

In some embodiments, the indication information may be transmitted to the remote terminal equipment by various means. For example, the indication information may be transmitted via at least one of the following: an RRC message (such as an RRC Reconfiguration, or RRC Setup, or RRC Resume, or RRC Re-establishment message), a PDCP control PDU, an MAC CE (media access control layer control element), or DCI (downlink control information).

In some embodiments, the indication information may be transmitted via the direct path and/or the indirect path. For example, the indication information may be transmitted via a primary path or a secondary path in the direct path and indirect path, or via a path with a lower payload in the direct path and indirect path, and so on.

In some embodiments, a validity of the indication information may be indicated by a timer or a duration. Thus, it is helpful to the remote terminal equipment in performing path switch more reasonably.

For example, in the case the validity of the indication information is indicated by a timer, the remote terminal equipment performs path selection or switch according to the indication information before the timer expires.

In some embodiments, the timer or duration may be included in the indication information, or the timer or duration may be configured by the network or predefined. However, this disclosure is not limited thereto, and the validity of the indication information may not be indicated. For example, after new indication information is received, previous indication information will automatically become invalid, and so on.

In some embodiments, the remote terminal equipment in a sidelink resource allocation mode (mode 2) may select more sidelink resources in a sidelink resource selection process. For example, the remote terminal equipment may select more sidelink resources than current resources, and/or select a higher modulation and coding scheme (MCS), and/or select more times of HARQ transmission. Thus, more data may be transmitted via the indirect path. In some embodiments, when the indication information includes the sidelink resource configuration information to which the payload information corresponds, the sidelink resource configuration information may configure a larger or greater number of times of HARQ retransmission and/or amount of frequency resources or range of amount of frequency resources and/or sidelink resource pool configuration than current ones. However, this disclosure is not limited thereto, for example, the remote terminal equipment in the sidelink resource allocation mode (mode 2) may also select fewer sidelink resources in the sidelink resource selection process.

In some embodiments, the remote terminal equipment may be configured or activated with a first path and a second path, wherein the first path may be a direct path, and the second path may be an indirect path; or, the first path may be an indirect path, and the second path may be a direct path.

FIG. 5 is a schematic diagram of the multi-path processing method of the embodiment of this disclosure. As shown in FIG. 5, the method may include:
501: transmitting data by the remote terminal equipment by using the first path and/or second path according to remaining PDBs (packet delay budgets) of sidelink data to be transmitted in a logical channel and/or the number of uplink grants or uplink resources of the first path and/or the number of SR (scheduling request) transmissions of the first path and/or the number of times of expiration of a loss timer.

It should be noted that FIG. 5 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

According to the above embodiment, the remote terminal equipment transmits data by using the first path and/or second path in the multi-path according to the remaining PDBs of sidelink data to be transmitted in the logical channel and/or the number of uplink grants or uplink resources of the first path in the multi-path and/or the number of SR transmissions of the first path and/or the number of times of expiration of the loss timer, which is helpful to the remote terminal equipment in efficiently and reasonably achieving path switch, and is advantageous to ensuring QoS of the services of the remote terminal equipment and improving utilization rates of network resources.

For example, the remote terminal equipment may select the first and/or the second path in the multi-path on its own for data transmission according to the above information, and does not need to receive indication information indicating path selection or switch from the network device, thus, signaling exchange may be reduced, and communication efficiency may be improved. However, this disclosure is not limited thereto, and the remote terminal equipment may also receive the indication information, for example, it may transmit data by using the first path and/or second path according to the indication information and/or the remaining PDBs of sidelink data to be transmitted in the logical channel and/or the number of uplink grants or uplink resources of the first path in the multi-path and/or the number of SR transmissions of the first path and/or the number of times of expiration of the loss timer.

In some embodiments, in 501, when the number of the remaining PDBs of sidelink data to be transmitted in the logical channel is less than a tenth threshold, the first path and/or the second path may be used for data transmission; and/or
when the number of uplink grants or uplink resources of the first path is less than an eleventh threshold for a period of time, the second path may be used for data transmission; and/or
when the number of SR transmissions of the first path reaches a preset threshold, the second path may be used for data transmission; and/or
when the number of times of expiration of the loss timer of the PDCP SDUs transmitted in the first path reaches a twelfth threshold, the second path may be used for data transmission.

Thus, the remote terminal equipment may efficiently and reasonably perform multi-path switch.

For example, when at least one of the following conditions is satisfied, the remote terminal equipment may use the indirect path for data transmission:
the number of the remaining PDBs of sidelink data to be transmitted in the logical channel is less than the tenth threshold;
the number of uplink grants or uplink resources of the direct path is less than the eleventh threshold for a period of time;
the number of SR transmissions of the direct path reaches the preset threshold; or
the number of times of expiration of the loss timer of the PDCP SDUs transmitted in the direct path reaches the twelfth threshold.

According to the above embodiment, at least a part of services in the direct path may be offloaded to the indirect path. Therefore, when congestion occurs in the direct path, data transmission may be performed via the indirect path, thereby reasonably performing channel switch and ensuring QoS of the services.

In some embodiments, the period of time and/or the tenth threshold and/or the eleventh threshold and/or the twelfth threshold is/are configured by the network, or is/are predefined.

In some embodiments, the preset threshold may be less than or equal to a maximum number of SR transmissions.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the steps related to this disclosure are described above; however, this disclosure is not limited thereto, and the method for transmitting failure information may further include other steps, and reference may be made to relevant techniques for contents of these steps.

It can be seen from the above embodiment that the remote terminal equipment transmits data by using the direct path and/or indirect path in the multi-path according to the indication information transmitted by the network device, or, the remote terminal equipment transmits data by using the first path and/or second path in the multi-path according to the remaining PDBs of sidelink data to be transmitted in the logical channel and/or the number of uplink grants or uplink resources of the first path in the multi-path and/or the number of SR transmissions of the first path and/or the number of times of expiration of the loss timer, which is helpful to the remote terminal equipment in efficiently and reasonably achieving path switch, and is advantageous to ensuring QoS of the services of the remote terminal equipment and improving utilization rates of network resources.

### Embodiment of a Second Aspect

The embodiment of this disclosure provides a multi-path processing method, applicable to a remote terminal equipment. The remote terminal equipment may be configured and/or activated with a first path and a second path, with contents identical to those in the embodiment of the first aspect being not going to be described herein any further. The embodiment of the second aspect may be implemented separately, or, the embodiment of the second aspect may be implemented in combination with the embodiment of the first aspect.

FIG. 6 is a schematic diagram of the multi-path processing method of the embodiment of the first aspect of this disclosure. As shown in FIG. 6, the method includes:
601: in a case where the first path fails and the second path is configured with SRB2 and is not configured with SRB1, transmitting failure information of the first path by the remote terminal equipment to a network device via SRB2 on the second path.

It should be noted that FIG. 6 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

According to the above embodiment, by transmitting the failure information of the first path to the network device via SRB2 on the second path, the path failure information may be transmitted more flexibly, thereby avoiding the remote terminal equipment from initiating RRC reestablishment, and reducing interruption times of services.

In some embodiments, the failure information may be included in an RRC message. However, this disclosure is not limited thereto, and the failure information may also be included in other messages.

In some embodiments, the failure information may include an identifier or index of an RLC bearer, such as identifier(s) or index/indices of a PC5 RLC bearer and/or a Uu RLC bearer. However, this disclosure is not limited thereto, and the failure information may also include other contents.

In some embodiments, SRB1 and SRB2 may be signaling radio bearers (SRBs) defined in 3GPP. For example, in Release 17 or earlier releases, SRB1 may be used for RRC messages and/or NAS messages before SRB2 is established, for example, path failure information may be transmitted via SRB1 or split SRB1; and SRB2 may be used for NAS messages, etc. In the above embodiment, by transmitting the path failure information via SRB2, flexibility of reporting of path failure information may be improved. In a multi-path scenario, when the first path fails, even if SRB1 is not configured for the second path, the path failure information may be reported via SRB2 of the second path, which may avoid the remote terminal equipment from initiating an RRC reestablishment process, and reduce interruption times of services.

In some embodiments, the above SRB2 may also be replaced with other SRBs, such as SRB0, SRB3, SRB4, or newly-defined SRBs. For example, in 601, when the first path fails, the remote terminal equipment may transmit the failure information of the first path to the network device via SRB2 and/or SRB0 and/or SRB3 and/or SRB4 and/or a newly-defined SRB on the second path, wherein SRB0, SRB3 and SRB4 may be SRBs defined in 3GPP, and the newly-defined SRB may be an SRB defined in future releases in 3GPP. Reference may be made to relevant technologies for definitions of SRB0, SRB3, SRB4 and the newly-defined SRB, which shall not be repeated herein any further.

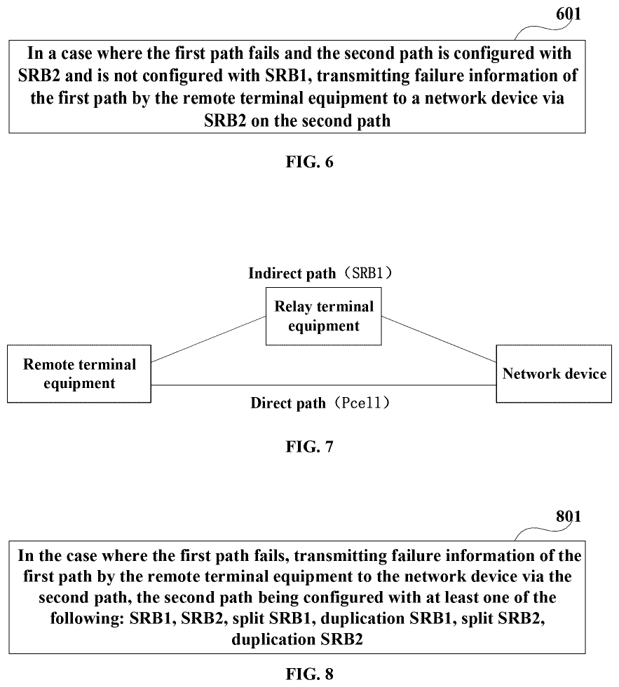

FIG. 7 is a schematic diagram of a multi-path scenario of the embodiment of this disclosure. In some embodiments, as shown in FIG. 7, when the remote terminal equipment performs multi-path operations, a PCell may be supported only on the direct path. Taking that SRB1 is configured in the indirect path and a path error occurs in the indirect path as an example, in a case where SRB1 is not configured in the direct path and SRB2 is configured in the direct path, the path failure information of the indirect path may be reported via SRB2 of the direct path. Hence, it may be avoided that the remote terminal equipment initiates an RRC reestablishment process when the direct path where the PCell is located is able to work normally, thereby reducing interruption times of services.

In some embodiments, in the multi-path scenario, SRB1 and SRB2 may be configured in the direct path; or, SRB1 and SRB2 may be configured in the indirect paths; or, SRB1 and SRB2 may be configured in the direct path and the indirect path; or, SRB1 is configured in the direct path and SRB2 is configured in the indirect path; or, SRB1 is configured in the indirect path and SRB2 is configured in the direct path; or, SRB1 is configured in both the direct path and the indirect path, and SRB2 is configured in the indirect path; or, SRB1 is configured in the direct path, and SRB2 is configured in both the direct path and the indirect path; or, SRB1 is configured in the indirect path, and SRB2 is configured in both the direct path and the indirect path; or, SRB2 is configured in the direct path, and SRB1 is configured in both the direct path and the indirect path.

In some embodiments, path transmission modes may include split transmission and duplication transmission. When the split transmission is used, different data or information may be transmitted in the direct path and the indirect path. Hence, throughput may be increased. When the duplication transmission is used, identical data or information may be transmitted in the direct path and the indirect path. Thus, reliability of transmission of data or information by the remote terminal equipment may be ensured.

SRB1 may be configured on the direct path and the indirect path in split SRB1 or duplication SRB1. For example, different SRB1 may be transmitted in split SRB1 on the direct path and indirect path, and identical SRB1 may be transmitted in duplication SRB1 on the direct path and the indirect path.

SRB2 may be configured on the direct path and the indirect path as split SRB2 or duplication SRB2. For example, different SRB2 may be transmitted in split SRB2 on the direct path and indirect path, and identical SRB2 may be transmitted in duplication SRB2 on the direct path and the indirect path.

In some embodiments, the first path failure may include a path failure defined in 3GPP. For example, the first path failure may include at least one of the following cases where: the remote terminal equipment detects an RLF (radio link failure) of the PC5 interface of the remote terminal equipment; the remote terminal equipment receives a notification of an RLF of a Uu interface of the relay user equipment or an RRC (radio resource control) connection failure of the relay user equipment or a failure of switch of the relay user equipment or beam failure recovery (BFR) of the relay user equipment transmitted by the relay user equipment; the remote terminal equipment detects a beam failure of the PC5 interface or a failure in performing beam failure recovery (for example, the remote terminal equipment attempts to perform beam failure recovery after detecting a beam failure of the PC5 interface, but the recovery fails); establishment of PC5 connection between the remote terminal equipment and the relay user equipment fails, for example, the remote terminal equipment does not discover, select or reselect the relay user equipment, or does not receive a direct communication accept message from the relay user equipment, or receives a direct communication reject message from the relay user equipment, or is unable to follow configuration therein after receiving an RRC reconfiguration sidelink from the relay user equipment, or receives an RRC reconfiguration sidelink failure message from the relay user equipment, etc; the remote terminal equipment detects an RLF of the Uu interface of the remote terminal equipment, for example, the remote terminal equipment performs radio link monitoring (RLM) on the Uu interface and deems that an RLF is detected when timer T310 expires; the remote terminal equipment detects a beam failure of the Uu interface or a failure in performing BFR; synchronization reconfiguration of the PC5 interface and/or Uu interface of the remote terminal equipment fails, for example, the remote terminal equipment receives an RRC reconfiguration message containing a reconfiguration with sync IE transmitted by the network device, and executes path switch procedure on the PC5 interface, and/or executes a random access procedure on the Uu interface, but the process is unsuccessful (for example, a path switch timer or timer T304 expires, etc.); or, configuration of the PC5 interface and/or Uu interface of the remote terminal equipment fails, for example, the remote terminal equipment is unable to follow a PC5 interface and/or Uu interface configured by the network device.

In some embodiments, that the second path is configured with SRB2 may include that SRB2 is configured only on the second path (e.g. SRB2 is configured on the second path and is not configured on the first path), or, that SRB2 is configured as split SRB2 or duplication SRB2 (for example, SRB2 is configured on the first path and the second path).

In some embodiments, in the case where the second path is configured with SRB1, the remote terminal equipment may transmit the failure information of the first path to the network device via SRB1 on the second path. For example, in a case where the second path is configured with SRB1 and is not configured with SRB2, or in a case where the second path is configured with SRB1 and SRB2, failure information of the first path may be transmitted to the network device via SRB1 on the second path. However, this disclosure is not limited thereto, and in the case where the second path is configured with SRB1 and SRB2, the failure information of the first path may also be transmitted to the network device via SRB2 on the second path.

In some embodiments, that the second path is configured with SRB1 includes that: SRB1 is configured only on the second path (for example, SRB1 is configured on the second path and is not configured on the first path), or, SRB1 is configured as split SRB1 or duplication SRB1 (for example, SRB1 is configured on the first path and the second path).

In some embodiments, the above SRB2 may also be replaced with other SRBs, such as SRB0, SRB3, SRB4, or newly-defined SRBs.

FIG. 8 is another schematic diagram of the multi-path processing method of the embodiment of this disclosure. As shown in FIG. 8, the multi-path processing method includes:
801: in the case where the first path fails, transmitting failure information of the first path by the remote terminal equipment to the network device via the second path, the second path being configured with at least one of the following: SRB1, SRB2, split SRB1, duplication SRB1, split SRB2, duplication SRB2.

It should be noted that FIG. 8 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 8.

According to the above embodiment, in the case where the failure information of the first path is transmitted via the second path, the second path is configured with at least one of SRB1, SRB2, split SRB1, duplication SRB1, split SRB2, duplication SRB2. Hence, it may be avoided that the remote terminal equipment initiates RRC reestablishment, thereby reducing interruption times of services.

In some embodiments, in 801, the remote terminal equipment reports the failure information of the first path by using the SRB configured in the second path (such as at least one of SRB1, SRB2, split SRB1, duplication SRB1, split SRB2, duplication SRB2).

For example, in a case where the indirect path fails, failure information of the indirect path may be reported via the direct path, wherein at least one SRB is configured in the direct path: SRB1, SRB2, split SRB1, duplication SRB1, split SRB2, or duplication SRB2. The remote terminal equipment may use the SRB configured on the direct path to report the failure information of the indirect path. That, at least one SRB is limited to be configured on the direct path, which means that no SRB or split SRB or duplicate SRB is configured on the direct path is not allowed. Hence, it may be avoided that the remote terminal equipment initiates an RRC reestablishment process when the direct path is able to work normally, thereby reducing interruption times of services.

In some embodiments, the above SRB2 may also be replaced with other SRBs, such as SRB0, SRB3, SRB4, or newly-defined SRBs. For example, in 801, the second path may also be configured with at least one of the following: SRB1, SRB2, split SRB1, duplication SRB1, split SRB2, duplication SRB2, SRB0, split SRB0, duplication SRB0, SRB3, split SRB3, duplication SRB3, SRB4, split SRB4, duplication SRB4, a newly-defined SRB, a newly-defined split SRB, or a newly-defined duplication SRB, etc.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that by transmitting the failure information of the first path to the network device via SRB2 on the second path, or by configuring at least one of SRB1, SRB2, split SRB1, duplication SRB1, split SRB2, duplication SRB2 on the second path and transmitting the failure information of the first path to the network device via the SRB configured on the second path, the path failure information may be transmitted more flexibly, and initiating RRC reestablishment by the remote terminal equipment may be avoided, thereby reducing interruption times of services.

### Embodiment of a Third Aspect

The embodiment of this disclosure provides a multi-path processing method, applicable to a network device side, with contents identical to those in the embodiments of the first and second aspect being not going to be described herein any further.

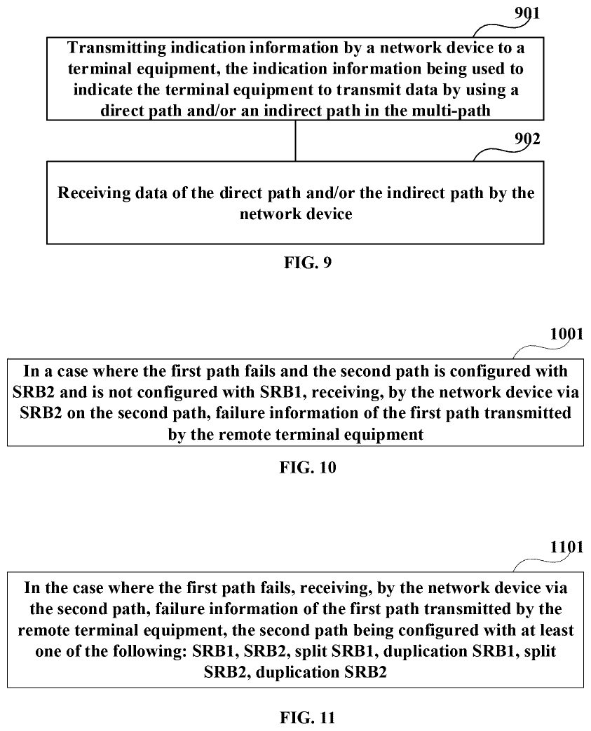

FIG. 9 is a schematic diagram of the multi-path processing method of the embodiment of this disclosure. As shown in FIG. 9, the method includes:
901: transmitting indication information by a network device to a terminal equipment, the indication information being used to indicate the terminal equipment to transmit data by using a direct path and/or an indirect path in the multi-path.

It should be noted that FIG. 9 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 9.

In some embodiments, the indication information includes at least one of the following:
indication on offloading to a direct path or an indirect path;
payload information on a direct path and/or an indirect path;
a utilization rate(s) of a direct path and/or an indirect path;
a first threshold related to a data amount of a PDCP layer; or
a radio bearer or QoS flow using a direct path, and/or a radio bearer or QoS flow using an indirect path, and/or a radio bearer or QoS flow using a direct path and an indirect path.

In some embodiments, the payload information indicates a payload level(s) and/or a payload proportion(s) of the direct path and/or the indirect path.

In some embodiments, the indication information may further include sidelink resource configuration information to which the payload information corresponds. For example, the configuration information may include at least one of the following: the number of times of HARQ retransmission, a frequency resource amount, a range of a frequency resource amount, and configuration of a sidelink resource pool (such as configuration of sidelink slot resources, etc.).

In some embodiments, the utilization rate(s) indicate(s) a proportion of an amount of traffics transmitted via the direct path and/or the indirect path, and/or indicate(s) a ratio of amounts of traffics of the direct path and indirect path.

In some embodiments, the radio bearer included in the indication information may be a signaling radio bearer (SRB) and/or a data radio bearer (DRB), wherein the SRB may include SRB1 and/or SRB2.

In some embodiments, the indication information includes a radio bearer or QoS flow using the direct path. For example, the indication information may indicate a DRB using the direct path (such as indicating by enumerating DRB IDs or using a DRB list) or a QoS flow (such as indicating by enumerating QoS flow IDs or using a QoS flow list), or may indicate a DRB ID or QoS flow ID to which a Uu RLC bearer corresponds; or, the indication information may indicate that a path to which a DRB or QoS flow corresponds is a direct path, or may indicate that an RLC bearer to which a DRB or QoS flow corresponds is a Uu RLC bearer, and it may additionally indicate other information, such as an identifier of a Uu RLC bearer.

In some embodiments, the indication information includes a radio bearer or QoS flow using the indirect path. For example, the indication information may indicate a DRB using the indirect path (such as indicating by enumerating DRB IDs or using a DRB list) or a QoS flow (such as indicating by enumerating QoS flow IDs or using a QoS flow list), or may indicate a DRB ID or QoS flow ID to which a PC5-RLC bearer corresponds; or, the indication information may indicate that a path to which a DRB or QoS flow corresponds is an indirect path, or may indicate that an RLC bearer to which a DRB or QoS flow corresponds is a PC5-RLC bearer, and it may additionally indicate other information, such as an identifier of a PC5-RLC bearer.

In some embodiments, the indication information includes a radio bearer or QoS flow using the indirect path and the indirect path. For example, the indication information may indicate a DRB using the indirect path and the indirect path (such as indicating by enumerating DRB IDs or using a DRB list) or a QoS flow (such as indicating by enumerating QoS flow IDs or using a QoS flow list), or may indicate that a Uu RLC bearer and a PC5-RLC bearer correspond to identical DRB IDs or QoS flow IDs; or, the indication information may indicate that paths to which a DRB or QoS flow corresponds are a direct path and an indirect path, or may indicate that an RLC bearer to which a DRB or QoS flow corresponds includes at least one Uu RLC bearer and at least one PC5-RLC bearer, and it may additionally indicate other information, such as an identifier of a Uu RLC bearer and/or an identifier of a PC5-RLC bearer.

In some embodiments, a DRB or a QoS flow may be configured as split transmission or duplication transmission. When it is configured as split transmission, different data of the PDCP layer are transmitted in the direct path and indirect path, or in the Uu RLC bearer and PC5-RLC bearer, and when it is configured as duplication transmission, identical data of the PDCP layer are transmitted in the direct path and indirect path, or in the Uu RLC bearer and PC5-RLC bearer.

In the above embodiment, the RLC bearer may also be expressed as an RLC channel or an RLC entity. For example, the Uu RLC bearer may also be expressed as a Uu RLC channel or a Uu RLC entity, and the PC5-RLC bearer may also be expressed as a PC5-RLC channel or a PC5 RLC entity.

In some embodiments, the indication information is transmitted via at least one of the following:
an RRC message, a PDCP control PDU, an MAC CE, or DCI.

In some embodiments, the indication information is transmitted via the direct path and/or the indirect path.

In some embodiments, a validity of the indication information is indicated by a timer or a duration.

In some embodiments, the timer or duration is included in the indication information, or the timer or duration is configured by the network or predefined.

In some embodiments, as shown in FIG. 9, the method further includes:
902: receiving data of the direct path and/or the indirect path by the network device.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that by transmitting the indication information by the network device to the remote terminal equipment, the remote terminal equipment is enabled to transmit data by using the direct path and/or the indirect path in the multi-path according to the indication information transmitted by the network device, which is helpful to efficiently and reasonably achieve path switch, and is advantageous to ensuring QOS of the services of the remote terminal equipment and improving utilization rates of network resources.

### Embodiment of a Fourth Aspect

The embodiment of this disclosure provides a multi-path processing method, applicable to a network device side. a first path and a second path are configured and/or activated between the network device and a remote terminal equipment, with contents identical to those in the embodiments of the first to third aspects being not going to be described herein any further. The embodiment of the fourth aspect may be implemented separately, or, the embodiment of the second aspect may be implemented in combination with the embodiment of the third aspect.

FIG. 10 is a schematic diagram of the multi-path processing method of the embodiment of the first aspect of this disclosure. As shown in FIG. 10, the method includes:
1001: in a case where the first path fails and the second path is configured with SRB2 and is not configured with SRB1, receiving, by the network device via SRB2 on the second path, failure information of the first path transmitted by the remote terminal equipment.

In some embodiments, that the second path is configured with SRB2 may include that SRB2 is configured only on the second path, or, that SRB2 is configured as split SRB2 or duplication SRB2.

In some embodiments, in the case where the second path is configured with SRB1, the failure information of the first path transmitted by the remote terminal equipment is received via SRB1 on the second path.

In some embodiments, that the second path is configured with SRB1 includes that: SRB1 is configured only on the second path, or, SRB1 is configured as split SRB1 or duplication SRB1.

FIG. 11 is a schematic diagram of the multi-path processing method of the embodiment of this disclosure. As shown in FIG. 11, the method includes:
1101: in the case where the first path fails, receiving, by the network device via the second path, failure information of the first path transmitted by the remote terminal equipment, the second path being configured with at least one of the following: SRB1, SRB2, split SRB1, duplication SRB1, split SRB2, duplication SRB2.

In some embodiments, the failure information may be included in an RRC message.

In some embodiments, the failure information may include an identifier or index of an RLC bearer, such as identifier(s) or index/indices of a PC5 RLC bearer and/or a Uu RLC bearer.

In some embodiments, the above SRB2 may be replaced with other SRBs, such as SRB0, SRB3, SRB4, or newly-defined SRBs.

In some embodiments, the first path is a direct path and the second path is an indirect path; or, the first path is an indirect path and the second path is a direct path.

It should be noted that FIG. 10 and FIG. 11 only schematically illustrate the embodiment of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what are contained in FIG. 10 and FIG. 11.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that by receiving the failure information of the first path via SRB2 on the second path, or by configuring at least one of SRB1, SRB2, split SRB1, duplication SRB1, split SRB2, duplication SRB2 on the second path and receiving the failure information of the first path via the SRB configured on the second path, the path failure information may be received more flexibly, and initiating RRC reestablishment by the remote terminal equipment may be avoided, thereby reducing interruption times of services.

### Embodiment of a Fifth Aspect

The embodiment of this disclosure provides a multi-path processing apparatus. The apparatus may be, for example, a remote terminal equipment, or may be one or some components or assemblies configured in the remote terminal equipment, with contents identical to those in the embodiment of the first aspect being not going to be described herein any further.

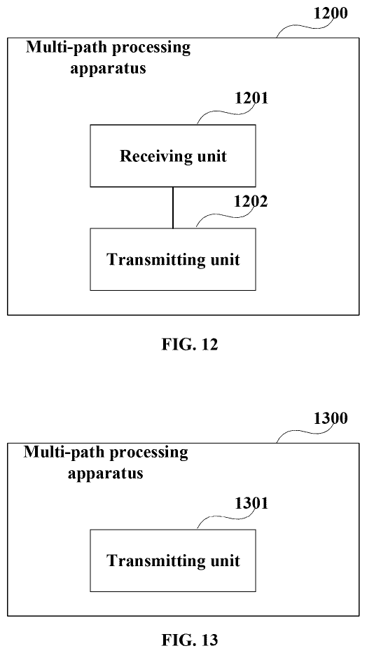

FIG. 12 is a schematic diagram of the multi-path processing apparatus of the embodiment of the sixth aspect of this disclosure. As shown in FIG. 12, the multi-path processing apparatus 1200 includes:
a receiving unit 1201 configured to receive indication information transmitted by a network device; and
a transmitting unit 1202 configured to transmit data by using a direct path and/or an indirect path in the multi-path according to the indication information.

In some embodiments, the indication information includes at least one of the following:
indication on offloading to a direct path or an indirect path;
payload information on a direct path and/or an indirect path;
a utilization rate(s) of a direct path and/or an indirect path;
a first threshold related to a data amount of a PDCP layer; or
a radio bearer or QoS flow using a direct path, and/or a radio bearer or QoS flow using an indirect path, and/or a radio bearer or QoS flow using a direct path and an indirect path.

In some embodiments, in a case where the indication information includes the indication on offloading to a direct path or an indirect path, data of the PDCP layer are transmitted via the direct path or indirect path.

In some embodiments, the payload information indicates a payload level(s) and/or a payload proportion(s) of the direct path and/or the indirect path.

In some embodiments, the indication information may further include sidelink resource configuration information to which the payload information corresponds, for example, the configuration information may include at least one of the following: the number of times of HARQ retransmission, a frequency resource amount, a range of a frequency resource amount, and configuration of a sidelink resource pool (such as configuration of sidelink slot resources, etc.).

In some embodiments, in a case where the indication information includes the payload information,
when the payload of the direct path is indicated to be high or the payload proportion of the direct path exceeds a second threshold, the data are transmitted by using the indirect path; and/or
when the payload of the indirect path is indicated to be high or the payload proportion of the indirect path exceeds a third threshold, the data are transmitted by using the direct path; and/or
when the payload of the direct path is indicated to be low or the payload proportion of the direct path is lower than a fourth threshold, the data are transmitted by using the direct path; and/or
when the payload of the indirect path is indicated to be low or the payload proportion of the indirect path exceeds a fifth threshold, the data are transmitted by using the indirect path; and/or
when the payloads of both the direct path and the indirect path are indicated to be high or the payload proportions of the direct path and the indirect path exceed a sixth threshold and a seventh threshold respectively, the data are transmitted by using the direct path and/or the indirect path; and/or
when the payloads of both the direct path and the indirect path are indicated to be low or the payload proportions of the direct path and the indirect path are lower than an eighth threshold and a ninth threshold respectively, the data are transmitted by using the direct path and/or the indirect path; and/or
when the indication information includes the sidelink resource configuration information to which the payload information corresponds, the sidelink resource configuration information is used to perform sidelink resource selection.

In some embodiments, the utilization rate(s) indicate(s) a proportion of an amount of traffics transmitted via the direct path and/or the indirect path, and/or indicate(s) a ratio of amounts of traffics of the direct path and indirect path.

In some embodiments, in a case where the indication information includes the utilization rate(s),
data transmission of corresponding amount of traffics is performed in the direct path and/or indirect path according to the utilization rate(s).

In some embodiments, in a case where the indication information includes the first threshold,
when the data amount of the PDCP layer is greater than the first threshold, the data are transmitted by using the indirect path and/or the direct path; and/or
when the data amount of the PDCP layer is less than the first threshold, the data are transmitted by using the indirect path and/or the direct path.

In some embodiments, the radio bearer included in the indication information may be a signaling radio bearer (SRB) and/or a data radio bearer (DRB), wherein the SRB may include SRB1 and/or SRB2.

In some embodiments, the indication information includes a radio bearer or QoS flow using the direct path. For example, the indication information may indicate a DRB using the direct path (such as indicating by enumerating DRB IDs or using a DRB list) or a QoS flow (such as indicating by enumerating QoS flow IDs or using a QoS flow list), or may indicate a DRB ID or QoS flow ID to which a Uu RLC bearer corresponds; or, the indication information may indicate that a path to which a DRB or QoS flow corresponds is a direct path, or may indicate that an RLC bearer to which a DRB or QoS flow corresponds is a Uu RLC bearer, and it may additionally indicate other information, such as an identifier of a Uu RLC bearer.

In some embodiments, the indication information includes a radio bearer or QoS flow using the indirect path. For example, the indication information may indicate a DRB using the indirect path (such as indicating by enumerating DRB IDs or using a DRB list) or a QoS flow (such as indicating by enumerating QoS flow IDs or using a QoS flow list), or may indicate a DRB ID or QoS flow ID to which a PC5-RLC bearer corresponds; or, the indication information may indicate that a path to which a DRB or QoS flow corresponds is an indirect path, or may indicate that an RLC bearer to which a DRB or QoS flow corresponds is a PC5-RLC bearer, and it may additionally indicate other information, such as an identifier of a PC5-RLC bearer.

In some embodiments, the indication information includes a radio bearer or QoS flow using the indirect path and the indirect path. For example, the indication information may indicate a DRB using the indirect path and the indirect path (such as indicating by enumerating DRB IDs or using a DRB list) or a QoS flow (such as indicating by enumerating QoS flow IDs or using a QoS flow list), or may indicate that a Uu RLC bearer and a PC5-RLC bearer correspond to identical DRB IDs or QoS flow IDs; or, the indication information may indicate that paths to which a DRB or QoS flow corresponds are a direct path and an indirect path, or may indicate that an RLC bearer to which a DRB or QoS flow corresponds includes at least one Uu RLC bearer and at least one PC5-RLC bearer, and it may additionally indicate other information, such as an identifier of a Uu RLC bearer and/or an identifier of a PC5-RLC bearer.

In some embodiments, a DRB or a QoS flow may be configured as split transmission or duplication transmission. When it is configured as split transmission, different data of the PDCP layer are transmitted in the direct path and indirect path, or in the Uu RLC bearer and PC5-RLC bearer, and when it is configured as duplication transmission, identical data of the PDCP layer are transmitted in the direct path and indirect path, or in the Uu RLC bearer and PC5-RLC bearer.

In the above embodiment, the RLC bearer may also be expressed as an RLC channel or an RLC entity. For example, the Uu RLC bearer may also be expressed as a Uu RLC channel, and the PC5-RLC bearer may also be expressed as a PC5-RLC channel.

In some embodiments, in the case where the indication information includes the radio bearer or QoS flow using the direct path, data of the radio bearer or QoS flow are transmitted by using the direct path.

In some embodiments, in the case where the indication information includes the radio bearer or QoS flow using the indirect path,
data of the radio bearer or QoS flow are transmitted by using the indirect path.

In some embodiments, in the case where the indication information includes the radio bearer or QoS flow using the direct path and the indirect path,
data of the radio bearer or QoS flow using the direct path and the indirect path are transmitted by using the direct path and the indirect path.

In some embodiments, the indication information is transmitted via at least one of the following:
an RRC message, or a PDCP control PDU, an MAC CE, or DCI.

In some embodiments, the indication information is transmitted via the direct path and/or the indirect path.

In some embodiments, a validity of the indication information is indicated by a timer or a duration.

In some embodiments, the timer or duration is included in the indication information, or the timer or duration is configured by the network or predefined.

In some embodiments, the remote terminal equipment is configured or activated with a first path and a second path. FIG. 13 is another schematic diagram of the multi-path processing apparatus of the embodiment of this disclosure. As shown in FIG. 13, the multi-path processing apparatus may include:
a transmitting unit 1301 configured to transmit data by using the first path and/or second path according to remaining PDBs of sidelink data to be transmitted in a logical channel and/or the number of uplink grants or uplink resources of the first path and/or the number of SR transmissions of the first path and/or the number of times of expiration of a loss timer.

In some embodiments, when the number of the remaining PDBs of sidelink data to be transmitted in the logical channel is less than a tenth threshold, the first path and/or the second path is/are used for data transmission; and/or
when the number of uplink grants or uplink resources of the first path is less than an eleventh threshold for a period of time, the second path is used for data transmission; and/or
when the number of SR transmissions of the first path reaches a preset threshold, the second path is used for data transmission; and/or
when the number of times of expiration of the loss timer of the PDCP SDUs transmitted in the first path reaches a twelfth threshold, the second path is used for data transmission.

In some embodiments, the period of time and/or the tenth threshold and/or the eleventh threshold and/or the twelfth threshold is/are configured by the network, or is/are predefined.

In some embodiments, the first path is a direct path and the second path is an indirect path; or, the first path is an indirect path and the second path is a direct path.

In some embodiments, the remote terminal equipment in a sidelink resource allocation mode (mode 2) may select more sidelink resources in a sidelink resource selection process.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner. For example, the transmitting unit 1301 may also be the transmitting unit 1202.

It should be noted that the components or modules related to this disclosure are only described above. However, this disclosure is not limited thereto, and the multi-path processing apparatus 1200 or 1300 may further include other components or modules, and reference may be made to related techniques for particulars of these components or modules.

Furthermore, for the sake of simplicity, connection relationships between the components or modules or signal profiles thereof are only illustrated in FIGS. 12 and 13. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the remote terminal equipment transmits data by using the direct path and/or indirect path in the multi-path according to the indication information transmitted by the network device, or, the remote terminal equipment transmits data by using the first path and/or second path in the multi-path according to the remaining PDBs of sidelink data to be transmitted in the logical channel and/or the number of uplink grants or uplink resources of the first path in the multi-path and/or the number of SR transmissions of the first path and/or the number of times of expiration of the loss timer, which is helpful to the remote terminal equipment in efficiently and reasonably achieving path switch, and is advantageous to ensuring QoS of the services of the remote terminal equipment and improving utilization rates of network resources.

### Embodiment of a Sixth Aspect

The embodiment of this disclosure provides a multi-path processing apparatus. The apparatus may be, for example, a remote terminal equipment, or may be one or some components or assemblies configured in the remote terminal equipment, with contents identical to those in the embodiment of the second aspect being not going to be described herein any further.

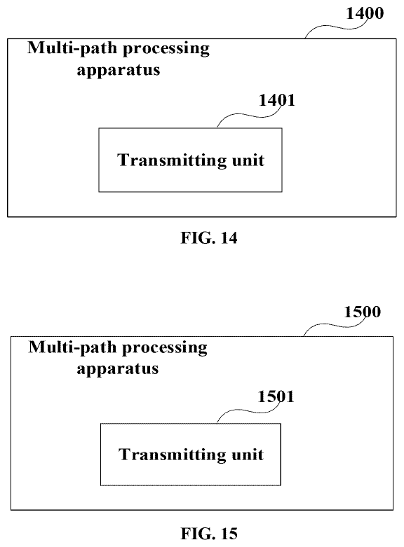

In some embodiments, the remote terminal equipment is configured or activated with a first path and a second path. FIG. 14 is a schematic diagram of the multi-path processing apparatus of the embodiment of the sixth aspect of this disclosure. As shown in FIG. 14, the multi-path processing apparatus 1400 includes:
a transmitting unit 1401 configured to, in a case where the first path fails and the second path is configured with SRB2 and is not configured with SRB1, transmit failure information of the first path to a network device via SRB2 on the second path.

In some embodiments, that the second path is configured with SRB2 includes that SRB2 is configured only on the second path, or, that SRB2 is configured as split SRB2 or duplication SRB2. In some embodiments, in the case where the second path is configured with SRB1, the failure information of the first path is transmitted to the network device via SRB1 on the second path.

In some embodiments, that the second path is configured with SRB1 includes that SRB1 is configured only on the second path, or, SRB1 is configured as split SRB1 or duplication SRB1.

FIG. 15 is another schematic diagram of the multi-path processing apparatus of the embodiment of this disclosure. As shown in FIG. 15, the multi-path processing apparatus 1500 includes: a transmitting unit 1501. In a case where the first path fails, the transmitting unit 1501 transmits failure information of the first path to a network device via the second path, the second path being configured with at least one of the following: SRB1, SRB2, split SRB1, duplication SRB1, split SRB2, duplication SRB2.

In some embodiments, the first path is a direct path and the second path is an indirect path; or, the first path is an indirect path and the second path is a direct path.

In some embodiments, the failure information may be included in an RRC message.

In some embodiments, the failure information may include an identifier or index of an RLC bearer, such as identifier(s) or index/indices of a PC5 RLC bearer and/or a Uu RLC bearer.

In some embodiments, the above SRB2 may be replaced with other SRBs, such as SRB0, SRB3, SRB4, or newly-defined SRBs.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner. For example, the transmitting unit 1401 may also be the transmitting unit 1501, and the transmitting unit 1401 and/or the transmitting unit 1501 may also be the transmitting unit 1301 and/or the transmitting unit 1202.

It should be noted that the components or modules related to this disclosure are only described above. However, this disclosure is not limited thereto, and the multi-path processing apparatus 1400 or 1500 may further include other components or modules, and reference may be made to related techniques for particulars of these components or modules.

Furthermore, for the sake of simplicity, connection relationships between the components or modules or signal profiles thereof are only illustrated in FIGS. 14 and 15. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that by transmitting the failure information of the first path to the network device via SRB2 on the second path, or by configuring at least one of SRB1, SRB2, split SRB1, duplication SRB1, split SRB2, duplication SRB2 on the second path and transmitting the failure information of the first path to the network device via the SRB configured on the second path, the path failure information may be transmitted more flexibly, and initiating RRC reestablishment by the remote terminal equipment may be avoided, thereby reducing interruption times of services.

### Embodiment of a Seventh Aspect

The embodiment of this disclosure provides a multi-path processing apparatus. The apparatus may be, for example, a network device, or may be one or some components or assemblies configured in the network device, with contents identical to those in the embodiment of the third aspect being not going to be described herein any further.

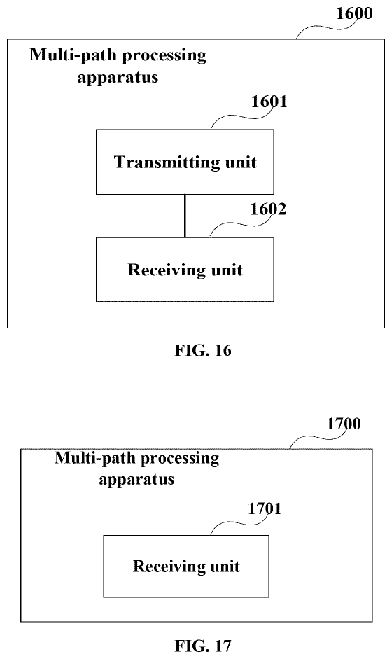

FIG. 16 is a schematic diagram of the multi-path processing apparatus of the embodiment of this disclosure. As shown in FIG. 16, the multi-path processing apparatus 1600 includes:
a transmitting unit 1601 configured to transmit indication information to a terminal equipment, the indication information being used to indicate the terminal equipment to transmit data by using a direct path and/or an indirect path in the multi-path.

In some embodiments, the indication information includes at least one of the following:
indication on offloading to a direct path or an indirect path;
payload information on a direct path and/or an indirect path;
a utilization rate(s) of a direct path and/or an indirect path;
a first threshold related to a data amount of a PDCP layer; or
a radio bearer or QoS flow using a direct path, and/or a radio bearer or QoS flow using an indirect path, and/or a radio bearer or QoS flow using a direct path and an indirect path.

In some embodiments, the payload information indicates a payload level(s) and/or a payload proportion(s) of the direct path and/or the indirect path.

In some embodiments, the indication information may further include sidelink resource configuration information to which the payload information corresponds. For example, the configuration information may include at least one of the following: the number of times of HARQ retransmission, a frequency resource amount, a range of a frequency resource amount, and configuration of a sidelink resource pool (such as configuration of sidelink slot resources, etc.).

In some embodiments, the utilization rate(s) indicate(s) a proportion of an amount of traffics transmitted via the direct path and/or the indirect path, and/or indicate(s) a ratio of amounts of traffics of the direct path and indirect path.

In some embodiments, the radio bearer included in the indication information may be a signaling radio bearer (SRB) and/or a data radio bearer (DRB), wherein the SRB may include SRB1 and/or SRB2.

In some embodiments, the indication information includes a radio bearer or QoS flow using the direct path. For example, the indication information may indicate a DRB using the direct path (such as indicating by enumerating DRB IDs or using a DRB list) or a QoS flow (such as indicating by enumerating QoS flow IDs or using a QoS flow list), or may indicate a DRB ID or QoS flow ID to which a Uu RLC bearer corresponds; or, the indication information may indicate that a path to which a DRB or QoS flow corresponds is a direct path, or may indicate that an RLC bearer to which a DRB or QoS flow corresponds is a Uu RLC bearer, and it may additionally indicate other information, such as an identifier of a Uu RLC bearer.

In some embodiments, the indication information includes a radio bearer or QoS flow using the indirect path. For example, the indication information may indicate a DRB using the indirect path (such as indicating by enumerating DRB IDs or using a DRB list) or a QoS flow (such as indicating by enumerating QoS flow IDs or using a QoS flow list), or may indicate a DRB ID or QoS flow ID to which a PC5-RLC bearer corresponds; or, the indication information may indicate that a path to which a DRB or QoS flow corresponds is an indirect path, or may indicate that an RLC bearer to which a DRB or QoS flow corresponds is a PC5-RLC bearer, and it may additionally indicate other information, such as an identifier of a PC5-RLC bearer.

In some embodiments, the indication information includes a radio bearer or QoS flow using the indirect path and the indirect path. For example, the indication information may indicate a DRB using the indirect path and the indirect path (such as indicating by enumerating DRB IDs or using a DRB list) or a QoS flow (such as indicating by enumerating QoS flow IDs or using a QoS flow list), or may indicate that a Uu RLC bearer and a PC5-RLC bearer correspond to identical DRB IDs or QoS flow IDs; or, the indication information may indicate that paths to which a DRB or QoS flow corresponds are a direct path and an indirect path, or may indicate that an RLC bearer to which a DRB or QoS flow corresponds includes at least one Uu RLC bearer and at least one PC5-RLC bearer, and it may additionally indicate other information, such as an identifier of a Uu RLC bearer and/or an identifier of a PC5-RLC bearer.

In some embodiments, a DRB or a QoS flow may be configured as split transmission or duplication transmission. When it is configured as split transmission, different data of the PDCP layer are transmitted in the direct path and indirect path, or in the Uu RLC bearer and PC5-RLC bearer, and when it is configured as duplication transmission, identical data of the PDCP layer are transmitted in the direct path and indirect path, or in the Uu RLC bearer and PC5-RLC bearer.

In the above embodiment, the RLC bearer may also be expressed as an RLC channel or an RLC entity. For example, the Uu RLC bearer may also be expressed as a Uu RLC channel or a Uu RLC entity, and the PC5-RLC bearer may also be expressed as a PC5-RLC channel or a PC5 RLC entity.

In some embodiments, the indication information is transmitted via at least one of the following:
an RRC message, a PDCP control PDU, an MAC CE, or DCI.

In some embodiments, the indication information is transmitted via the direct path and/or the indirect path.

In some embodiments, a validity of the indication information is indicated by a timer or a duration.

In some embodiments, the timer or duration is included in the indication information, or the timer or duration is configured by the network or predefined.

In some embodiments, as shown in FIG. 16, the apparatus further includes:
a receiving unit 1602 configured to receive data of the direct path and/or the indirect path.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1600 may further include other components or modules, and reference may be made to related techniques for particulars of these components or modules.

Furthermore, for the sake of simplicity, connection relationships between the components or modules or signal profiles thereof are only illustrated in FIG. 16. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that by transmitting the indication information by the network device to the remote terminal equipment, the remote terminal equipment is enabled to transmit data by using the direct path and/or the indirect path in the multi-path according to the indication information transmitted by the network device, which is helpful to efficiently and reasonably achieve path switch, and is advantageous to ensuring QoS of the services of the remote terminal equipment and improving utilization rates of network resources.

### Embodiment of an Eighth Aspect

The embodiment of this disclosure provides a multi-path processing apparatus. The apparatus may be, for example, a network device, or may be one or some components or assemblies configured in the network device, with contents identical to those in the embodiment of the fourth aspect being not going to be described herein any further.

In some embodiments, a first path and a second path are configured and/or activated between the network device and a remote terminal equipment. FIG. 17 is a schematic diagram of the multi-path processing apparatus of the embodiment of this disclosure. As shown in FIG. 17, the multi-path processing apparatus 1700 includes:
a receiving unit 1701 configured to, in a case where the first path fails and the second path is configured with SRB2 and is not configured with SRB1, receive via SRB2 on the second path, failure information of the first path transmitted by the remote terminal equipment.

In some embodiments, that the second path is configured with SRB2 may include that SRB2 is configured only on the second path, or, that SRB2 is configured as split SRB2 or duplication SRB2.

In some embodiments, in the case where the second path is configured with SRB1, the failure information of the first path transmitted by the remote terminal equipment is received via SRB1 on the second path.

In some embodiments, that the second path is configured with SRB1 includes that: SRB1 is configured only on the second path, or, SRB1 is configured as split SRB1 or duplication SRB1.

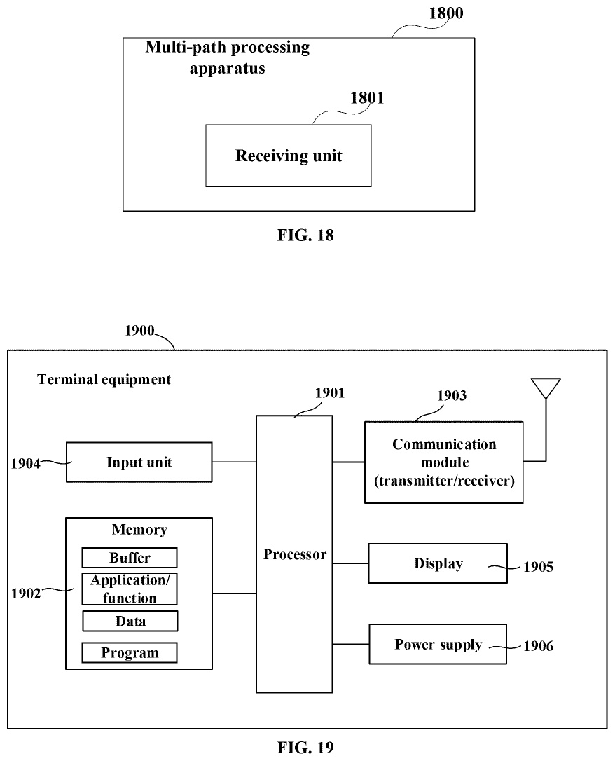

FIG. 18 is another schematic diagram of the multi-path processing apparatus of the embodiment of this disclosure. As shown in FIG. 18, the multi-path processing apparatus 1800 includes:
a receiving unit 1801 configured to, in the case where the first path fails, receiving via the second path, failure information of the first path transmitted by the remote terminal equipment, the second path being configured with at least one of the following: SRB1, SRB2, split SRB1, duplication SRB1, split SRB2, duplication SRB2.

In some embodiments, the first path is a direct path and the second path is an indirect path; or, the first path is an indirect path and the second path is a direct path.

In some embodiments, the failure information may be included in an RRC message.

In some embodiments, the failure information may include an identifier or index of an RLC bearer, such as identifier(s) or index/indices of a PC5 RLC bearer and/or a Uu RLC bearer.

In some embodiments, the above SRB2 may be replaced with other SRBs, such as SRB0, SRB3, SRB4, or newly-defined SRBs.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner. For example, the receiving unit 1701 may be the receiving unit 1801, and the receiving unit 1701 and/or the receiving unit 1801 may be the receiving unit 1602.

It should be noted that the components or modules related to this disclosure are only described above. However, this disclosure is not limited thereto, and the multi-path processing apparatus 1700 or 1800 may further include other components or modules, and reference may be made to related techniques for particulars of these components or modules.

Furthermore, for the sake of simplicity, connection relationships between the components or modules or signal profiles thereof are only illustrated in FIGS. 17 and 18. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that by receiving the failure information of the first path via SRB2 on the second path, or by configuring at least one of SRB1, SRB2, split SRB1, duplication SRB1, split SRB2, duplication SRB2 on the second path and receiving the failure information of the first path via the SRB configured on the second path, the path failure information may be received more flexibly, and initiating RRC reestablishment by the remote terminal equipment may be avoided, thereby reducing interruption times of services.

### Embodiment of a Ninth Aspect

The embodiment of this disclosure provides a communication system, and reference may be made to FIG. 1, with contents identical to those in the embodiments of the first to the eighth aspects being not going to be described herein any further.

In some embodiments, the communication system 100 may at least include: a remote terminal equipment 101 and/or a network device 103.

In the embodiment of this disclosure, the remote terminal equipment 101 may be configured to carry out the multi-path processing method in the embodiment(s) of the first aspect and/or the second aspect, the contents of which being incorporated herein, which shall not be described herein any further.

In the embodiment of this disclosure, the network device 103 may be configured to carry out the multi-path processing method in the embodiment(s) of the third aspect and/or the fourth aspect, the contents of which being incorporated herein, which shall not be described herein any further.

The embodiment of this disclosure further provides a terminal equipment.

FIG. 19 is a schematic diagram of a structure of the terminal equipment of the embodiment of this disclosure. The terminal equipment may be a remote terminal equipment. As shown in FIG. 19, the terminal equipment 1900 may include a processor 1901 and a memory 1902, the memory 1902 storing data and a program and being coupled to the processor 1901. It should be noted that this figure is illustrative only, and other types of structures may also be used, so as to supplement or replace this structure and achieve a telecommunications function or other functions.

For example, the processor 1901 may be configured to execute a program to carry out the multi-path processing method in the embodiment of the first aspect. For example, the processor 1901 may be configured to executed the following operations: receiving indication information transmitted by a network device, and transmitting data by using a direct path and/or an indirect path in the multi-path according to the indication information; and/or, transmitting data by using the first path and/or second path according to remaining PDBs of sidelink data to be transmitted in a logical channel and/or the number of uplink grants or uplink resources of the first path and/or the number of SR transmissions of the first path and/or the number of times of expiration of a loss timer.

For another example, the processor 1901 may be configured to execute a program to carry out the multi-path processing method in the embodiment of the second aspect. For example, the processor 1901 may be configured to executed the following operations: in a case where the first path fails and the second path is configured with SRB2 and is not configured with SRB1, transmitting failure information of the first path by the remote terminal equipment to a network device via SRB2 on the second path; and/or, in the case where the first path fails, transmitting failure information of the first path by the remote terminal equipment to the network device via the second path, the second path being configured with at least one of the following: SRB1, SRB2, split SRB1, duplication SRB1, split SRB2, duplication SRB2.

As shown in FIG. 19, the terminal equipment 1900 may further include a communication module 1903, an input unit 1904, a display 1905, and a power supply 1906; wherein functions of the above components are similar to those in the related art, which shall not be described herein any further. It should be noted that the terminal equipment 1900 does not necessarily include all the parts shown in FIG. 19, and the above components are not necessary. Furthermore, the terminal equipment 1900 may include parts not shown in FIG. 19, and the related art may be referred to.

The embodiment of this disclosure further provides a network device, which may be, for example, a base station. However, this disclosure is not limited thereto, and it may also be another network device.

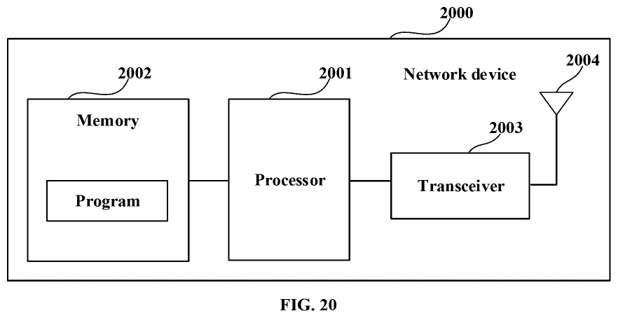

FIG. 20 is a schematic diagram of a structure of the network device of the embodiment of the seventh aspect of this disclosure. As shown in FIG. 20, the network device 2000 may include a processor 2001 (such as a central processing unit (CPU)) and a memory 2002, the memory 2002 being coupled to the processor 2001. Wherein, the memory 2002 may store various data, and furthermore, it may store a program for information processing, and execute the program under control of the processor 2001.

For example, the processor 2001 may be configured to execute a program to carry out the multi-path processing method in the embodiment of the third aspect. For example, the processor 2001 may be configured to executed the following operations: transmitting indication information to a terminal equipment, the indication information being used to indicate the terminal equipment to transmit data by using a direct path and/or an indirect path in the multi-path.

For another example, the processor 2001 may be configured to execute a program to carry out the multi-path processing method in the embodiment of the fourth aspect. For example, the processor 2001 may be configured to executed the following operations: in a case where the first path fails and the second path is configured with SRB2 and is not configured with SRB1, receiving via SRB2 on the second path, failure information of the first path transmitted by the remote terminal equipment; and/or, in the case where the first path fails, receiving via the second path, failure information of the first path transmitted by the remote terminal equipment, the second path being configured with at least one of the following: SRB1, SRB2, split SRB1, duplication SRB1, split SRB2, duplication SRB2.

Furthermore, as shown in FIG. 20, the network device 2000 may include a transceiver 2003, and an antenna 2005, etc. Wherein, functions of the above components are similar to those in the related art, and shall not be described herein any further. It should be noted that the network device 2000 does not necessarily include all the parts shown in FIG. 20, and furthermore, the network device 2000 may include parts not shown in FIG. 20, and the related art may be referred to.

An embodiment of this disclosure provides a computer readable program code, which, when executed in a remote terminal equipment, will cause a computer to carry out the multi-path processing method as described in the embodiment(s) of the first aspect and/or the second aspect in the remote terminal equipment.

An embodiment of this disclosure provides a computer readable medium, including a computer readable program code, which will cause a computer to carry out the multi-path processing method as described in the embodiment(s) of the first aspect and/or the second aspect in a remote terminal equipment.

An embodiment of this disclosure provides a computer readable program code, which, when executed in a network device, will cause a computer to carry out the multi-path processing method as described in the embodiment(s) of the third aspect and/or the fourth aspect in the network device.

An embodiment of this disclosure provides a computer readable medium, including a computer readable program code, which will cause a computer to carry out the multi-path processing method as described in the embodiment(s) of the third aspect and/or the fourth aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to implementations containing the above embodiments, following supplements are further disclosed.

### Information Processing Methods at a Terminal Equipment Side

### Part I

1. A multi-path processing method, applicable to a remote terminal equipment, the method including:
receiving indication information transmitted by a network device; and
transmitting data by using a direct path and/or an indirect path in the multi-path according to the indication information.

2. The method according to supplement 1, wherein the indication information includes at least one of the following:
indication on offloading to a direct path or an indirect path;
payload information on a direct path and/or an indirect path;
a utilization rate(s) of a direct path and/or an indirect path;
a first threshold related to a data amount of a PDCP layer; or
a radio bearer or QoS flow using a direct path, and/or a radio bearer or QoS flow using an indirect path, and/or a radio bearer or QoS flow using a direct path and an indirect path.

3. The method according to supplement 1, wherein,
in a case where the indication information includes the indication on offloading to a direct path or an indirect path, data of the PDCP layer are transmitted via the direct path or indirect path.

4. The method according to supplement 2, wherein,
the payload information indicates a payload level(s) and/or a payload proportion(s) of the direct path and/or the indirect path.

4a. The method according to supplement 2, wherein,
the indication information further includes sidelink resource configuration information to which the payload information corresponds.

4b. The method according to supplement 4a, wherein,
the configuration information includes at least one of the following: the number of times of HARQ retransmission, a frequency resource amount, a range of a frequency resource amount, and configuration of a sidelink resource pool.

5. The method according to supplement 2, wherein in a case where the indication information includes the payload information,
when the payload of the direct path is indicated to be high or the payload proportion of the direct path exceeds a second threshold, the data are transmitted by using the indirect path; and/or
when the payload of the indirect path is indicated to be high or the payload proportion of the indirect path exceeds a third threshold, the data are transmitted by using the direct path; and/or
when the payload of the direct path is indicated to be low or the payload proportion of the direct path is lower than a fourth threshold, the data are transmitted by using the direct path; and/or
when the payload of the indirect path is indicated to be low or the payload proportion of the indirect path exceeds a fifth threshold, the data are transmitted by using the indirect path; and/or
when the payloads of both the direct path and the indirect path are indicated to be high or the payload proportions of the direct path and the indirect path exceed a sixth threshold and a seventh threshold respectively, the data are transmitted by using the direct path and/or the indirect path; and/or
when the payloads of both the direct path and the indirect path are indicated to be low or the payload proportions of the direct path and the indirect path are lower than an eighth threshold and a ninth threshold respectively, the data are transmitted by using the direct path and/or the indirect path; and/or
when the indication information includes the sidelink resource configuration information to which the payload information corresponds, the sidelink resource configuration information is used to perform sidelink resource selection.

6. The method according to supplement 2, wherein,
the utilization rate(s) indicate(s) a proportion of an amount of traffics transmitted via the direct path and/or the indirect path, and/or indicate(s) a ratio of amounts of traffics of the direct path and indirect path.

7. The method according to supplement 2, wherein in a case where the indication information includes the utilization rate(s),
data transmission of corresponding amount of traffics is performed in the direct path and/or indirect path according to the utilization rate(s).

8. The method according to supplement 2, wherein in a case where the indication information includes the first threshold,
when the data amount of the PDCP layer is greater than the first threshold, the data are transmitted by using the indirect path and/or the direct path; and/or
when the data amount of the PDCP layer is less than the first threshold, the data are transmitted by using the indirect path and/or the direct path.

8aa. The method according to supplement 2, wherein,
the radio bearer included in the indication information is a signaling radio bearer (SRB) and/or a data radio bearer (DRB).

8ab. The method according to supplement 8aa, wherein,
the SRB includes SRB1 and/or SRB2.

8ac. The method according to supplement 2, wherein,
in the case where the indication information includes a radio bearer or QOS flow using the direct path, the indication information indicates a DRB or QoS flow using the direct path, or indicates a DRB ID or QoS flow ID to which a Uu RLC bearer corresponds; or, the indication information indicates that a path to which a DRB or QoS flow corresponds is a direct path, or indicates that an RLC bearer to which a DRB or QoS flow corresponds is a Uu RLC bearer.

8ad. The method according to supplement 2, wherein,
in the case where the indication information includes a radio bearer or QOS flow using the direct path, the indication information indicates a DRB or QoS flow using the indirect path, or indicates a DRB ID or QoS flow ID to which a PC5-RLC bearer corresponds; or, the indication information indicates that a path to which a DRB or QoS flow corresponds is an indirect path, or indicates that an RLC bearer to which a DRB or QoS flow corresponds is a PC5-RLC bearer.

8ae. The method according to supplement 2, wherein,
in the case where the indication information includes a radio bearer or QoS flow using the direct path and the indirect path, the indication information indicates a DRB or QoS flow using the indirect path and the indirect path, or indicates that a Uu RLC bearer and a PC5-RLC bearer correspond to identical DRB IDs or QoS flow IDs; or, the indication information indicates that paths to which a DRB or QoS flow corresponds are a direct path and an indirect path, or indicates that an RLC bearer to which a DRB or QoS flow corresponds includes at least one Uu RLC bearer and at least one PC5-RLC bearer.

8A. The method according to supplement 2, wherein in the case where the indication information includes the radio bearer or QoS flow using the direct path,
data of the radio bearer or QoS flow using the direct path are transmitted by using the direct path.

8B. The method according to supplement 2, wherein in the case where the indication information includes the radio bearer or QoS flow using the indirect path,
data of the radio bearer or QoS flow using the indirect path are transmitted by using the indirect path.

8C. The method according to supplement 2, wherein in the case where the indication information includes the radio bearer or QoS flow using the direct path and the indirect path,
data of the radio bearer or QoS flow using the direct path and the indirect path are transmitted by using the direct path and the indirect path.

9. The method according to supplement 1, wherein the indication information is transmitted via at least one of the following:
an RRC message, or a PDCP control PDU, an MAC CE, or DCI.

10. The method according to supplement 1, wherein,
the indication information is transmitted via the direct path and/or the indirect path.

11. The method according to supplement 1, wherein,
a validity of the indication information is indicated by a timer or a duration.

12. The method according to supplement 11, wherein,
the timer or duration is included in the indication information, or the timer or duration is configured by the network or predefined.

12a. The method according to supplement 1, wherein,
in a case where the remote terminal equipment is in a sidelink resource allocation mode (mode 2), more sidelink resources than current resources are selected in a sidelink resource selection process.

13. A multi-path processing method, applicable to a remote terminal equipment, wherein the remote terminal equipment is configured or activated with a first path and a second path, and the method includes:
transmitting data by using the first path and/or second path according to remaining PDBs of sidelink data to be transmitted in a logical channel and/or the number of uplink grants or uplink resources of the first path and/or the number of SR transmissions of the first path and/or the number of times of expiration of a loss timer.

14. The method according to supplement 13, wherein,
when the number of the remaining PDBs of sidelink data to be transmitted in the logical channel is less than a tenth threshold, the first path and/or the second path is/are used for data transmission; and/or
when the number of uplink grants or uplink resources of the first path is less than an eleventh threshold for a period of time, the second path is used for data transmission; and/or
when the number of SR transmissions of the first path reaches a preset threshold, the second path is used for data transmission; and/or
when the number of times of expiration of the loss timer of the PDCP SDUs transmitted in the first path reaches a twelfth threshold, the second path is used for data transmission.

15. The method according to supplement 14, wherein,
the period of time and/or the tenth threshold and/or the eleventh threshold and/or the twelfth threshold is/are configured by the network, or is/are predefined.

16. The method according to supplement 13, wherein,
the first path is a direct path and the second path is an indirect path; or, the first path is an indirect path and the second path is a direct path.

### Part II

1. A multi-path processing method, applicable to a remote terminal equipment, wherein the remote terminal equipment is configured or activated with a first path and a second path, and the method includes:
in a case where the first path fails and the second path is configured with SRB2 and is not configured with SRB1, transmitting failure information of the first path to a network device via SRB2 on the second path.

2. The method according to supplement 1, wherein,
that the second path is configured with SRB2 includes that SRB2 is configured only on the second path, or, that SRB2 is configured as split SRB2 or duplication SRB2.

3. The method according to supplement 1, wherein,
in the case where the second path is configured with SRB1, the failure information of the first path is transmitted to the network device via SRB1 on the second path.

4. The method according to supplement 3, wherein,
that the second path is configured with SRB1 includes that SRB1 is configured only on the second path, or, SRB1 is configured as split SRB1 or duplication SRB1.

5. The method according to supplement 1, wherein,
the first path is a direct path and the second path is an indirect path; or, the first path is an indirect path and the second path is a direct path.

6. A multi-path processing method, applicable to a remote terminal equipment, wherein the remote terminal equipment is configured or activated with a first path and a second path, and the method includes:
in a case where the first path fails, transmitting failure information of the first path to a network device via the second path, the second path being configured with at least one of the following: SRB1, SRB2, split SRB1, duplication SRB1, split SRB2, duplication SRB2.

7. The method according to supplement 6, wherein the method further includes:
the first path is a direct path and the second path is an indirect path; or, the first path is an indirect path and the second path is a direct path.

### Terminal Equipment

1. A terminal equipment, including a memory and a processor, the memory storing a computer program, and the processor being configured to execute the computer program to carry out the methods as described in the supplements regarding methods.

### Information Processing Methods at a Network Device Side

### Part I

1. A multi-path processing method, applicable to a network device, the method including:
transmitting indication information to a terminal equipment, the indication information being used to indicate the terminal equipment to transmit data by using a direct path and/or an indirect path in the multi-path.

2. The method according to supplement 1, wherein the indication information includes at least one of the following:
indication on offloading to a direct path or an indirect path;
payload information on a direct path and/or an indirect path;
a utilization rate(s) of a direct path and/or an indirect path;
a first threshold related to a data amount of a PDCP layer; or
a radio bearer or QoS flow using a direct path, and/or a radio bearer or QoS flow using an indirect path, and/or a radio bearer or QoS flow using a direct path and an indirect path.

3. The method according to supplement 2, wherein,
the payload information indicates a payload level(s) and/or a payload proportion(s) of the direct path and/or the indirect path.

3a. The method according to supplement 2, wherein,
the indication information further includes sidelink resource configuration information to which the payload information corresponds.

3b. The method according to supplement 3a, wherein,
the configuration information includes at least one of the following: the number of times of HARQ retransmission, a frequency resource amount, a range of a frequency resource amount, and configuration of a sidelink resource pool.

4. The method according to supplement 2, wherein,
the utilization rate(s) indicate(s) a proportion of an amount of traffics transmitted via the direct path and/or the indirect path, and/or indicate(s) a ratio of amounts of traffics of the direct path and indirect path.

5. The method according to supplement 1, wherein the indication information is transmitted via at least one of the following:
an RRC message, a PDCP control PDU, an MAC CE, or DCI.

6. The method according to supplement 1, wherein,
the indication information is transmitted via the direct path and/or the indirect path.

7. The method according to supplement 1, wherein,
a validity of the indication information is indicated by a timer or a duration.

8. The method according to supplement 1, wherein,
the timer or duration is included in the indication information, or the timer or duration is configured by the network or predefined.

9. The method according to supplement 1, wherein the method further includes:
receiving data of the direct path and/or the indirect path.

### Part II

1. A multi-path processing method, applicable to a network device, wherein a first path and a second path are configured or activated between the network device and a remote terminal equipment, and the method includes:
in a case where the first path fails and the second path is configured with SRB2 and is not configured with SRB1, receiving via SRB2 on the second path, failure information of the first path transmitted by the remote terminal equipment.

2. The method according to supplement 1, wherein,
that the second path is configured with SRB2 may include that SRB2 is configured only on the second path, or, that SRB2 is configured as split SRB2 or duplication SRB2.

3. The method according to supplement 1, wherein,
in the case where the second path is configured with SRB1, the failure information of the first path transmitted by the remote terminal equipment is received via SRB1 on the second path.

4. The method according to supplement 3, wherein,
that the second path is configured with SRB1 includes that: SRB1 is configured only on the second path, or, SRB1 is configured as split SRB1 or duplication SRB1.

5. The method according to supplement 1, wherein,
the first path is a direct path and the second path is an indirect path; or, the first path is an indirect path and the second path is a direct path.

6. A multi-path processing method, applicable to a network device, wherein a first path and a second path are configured or activated between the network device and a remote terminal equipment, and the method includes:
in a case where the first path fails, receiving via the second path, failure information of the first path transmitted by the remote terminal equipment, the second path being configured with at least one of the following: SRB1, SRB2, split SRB1, duplication SRB1, split SRB2, duplication SRB2.

7. The method according to supplement 6, wherein the method further includes:
the first path is a direct path and the second path is an indirect path; or, the first path is an indirect path and the second path is a direct path.

### Information Processing Apparatuses at a Network Device Side

### Part I

1. A multi-path processing apparatus, configured in a network device, the apparatus including:
a transmitting unit configured to transmit indication information to a terminal equipment, the indication information being used to indicate the terminal equipment to transmit data by using a direct path and/or an indirect path in the multi-path.

2. The apparatus according to supplement 1, wherein the indication information includes at least one of the following:
indication on offloading to a direct path or an indirect path;
payload information on a direct path and/or an indirect path;
a utilization rate(s) of a direct path and/or an indirect path;
a first threshold related to a data amount of a PDCP layer; or
a radio bearer or QoS flow using a direct path, and/or a radio bearer or QoS flow using an indirect path, and/or a radio bearer or QoS flow using a direct path and an indirect path.

3. The apparatus according to supplement 2, wherein,
the payload information indicates a payload level(s) and/or a payload proportion(s) of the direct path and/or the indirect path.

3a. The apparatus according to supplement 2, wherein,
the indication information further includes sidelink resource configuration information to which the payload information corresponds.

3b. The apparatus according to supplement 3a, wherein,
the configuration information includes at least one of the following: the number of times of HARQ retransmission, a frequency resource amount, a range of a frequency resource amount, and configuration of a sidelink resource pool.

4. The apparatus according to supplement 2, wherein,
the utilization rate(s) indicate(s) a proportion of an amount of traffics transmitted via the direct path and/or the indirect path, and/or indicate(s) a ratio of amounts of traffics of the direct path and indirect path.

5. The apparatus according to supplement 1, wherein the indication information is transmitted via at least one of the following:
an RRC message, a PDCP control PDU, an MAC CE, or DCI.

6. The apparatus according to supplement 1, wherein,
the indication information is transmitted via the direct path and/or the indirect path.

7. The apparatus according to supplement 1, wherein,
a validity of the indication information is indicated by a timer or a duration.

8. The apparatus according to supplement 1, wherein,
the timer or duration is included in the indication information, or the timer or duration is configured by the network or predefined.

9. The apparatus according to supplement 1, wherein the apparatus further includes:
a receiving unit configured to receive data of the direct path and/or the indirect path.

### Part II

1. A multi-path processing apparatus, configured in a network device, wherein a first path and a second path are configured or activated between the network device and a remote terminal equipment, and the apparatus includes:
a receiving unit configured to, in a case where the first path fails and the second path is configured with SRB2 and is not configured with SRB1, receive via SRB2 on the second path, failure information of the first path transmitted by the remote terminal equipment.

2. The apparatus according to supplement 1, wherein,
that the second path is configured with SRB2 may include that SRB2 is configured only on the second path, or, that SRB2 is configured as split SRB2 or duplication SRB2.

3. The apparatus according to supplement 1, wherein,
in the case where the second path is configured with SRB1, the failure information of the first path transmitted by the remote terminal equipment is received via SRB1 on the second path.

4. The apparatus according to supplement 3, wherein,
that the second path is configured with SRB1 includes that: SRB1 is configured only on the second path, or, SRB1 is configured as split SRB1 or duplication SRB1.

5. The apparatus according to supplement 1, wherein,
the first path is a direct path and the second path is an indirect path; or, the first path is an indirect path and the second path is a direct path.

6. A multi-path processing apparatus, configured in a network device, wherein a first path and a second path are configured or activated between the network device and a remote terminal equipment, and the apparatus includes:
a receiving unit configured to, in a case where the first path fails, receive via the second path, failure information of the first path transmitted by the remote terminal equipment, the second path being configured with at least one of the following: SRB1, SRB2, split SRB1, duplication SRB1, split SRB2, duplication SRB2.

7. The apparatus according to supplement 6, wherein the apparatus further includes:
the first path is a direct path and the second path is an indirect path; or, the first path is an indirect path and the second path is a direct path.

### Network Device

1. A network device, including a memory and a processor, the memory storing a computer program, and the processor being configured to execute the computer program to carry out the methods as described in the supplements regarding methods.

### Communication System

1. A communication system, including the above network device and remote terminal equipment.

1. A multi-path processing apparatus, configured in a remote terminal equipment, the apparatus comprising:
a receiver configured to receive indication information transmitted by a network device; and
a transmitter configured to transmit data by using a direct path or an indirect path in the multi-path according to the indication information,
wherein the indication information comprises a first threshold related to a data amount of a PDCP (packet data convergence protocol) layer.

2. The apparatus according to claim 1, wherein the indication information further comprises at least one of the following:
indication on offloading to a direct path or an indirect path;
payload information on a direct path and/or an indirect path;
a utilization rate(s) of a direct path and/or an indirect path; or
a radio bearer or QoS (quality of service) flow using a direct path, and/or a radio bearer or QoS flow using an indirect path, and/or a radio bearer or QoS flow using a direct path and an indirect path.

3. The apparatus according to claim 2, wherein,
in a case where the indication information comprises the indication on offloading to a direct path or an indirect path, data of the PDCP layer are transmitted via the direct path or indirect path.

4. The apparatus according to claim 2, wherein,
the payload information indicates a payload level(s) and/or a payload proportion(s) of the direct path and/or the indirect path.

5. The apparatus according to claim 2, wherein in a case where the indication information comprises the payload information,
when the payload of the direct path is indicated to be high or the payload proportion of the direct path exceeds a second threshold, the data are transmitted by using the indirect path; and/or
when the payload of the indirect path is indicated to be high or the payload proportion of the indirect path exceeds a third threshold, the data are transmitted by using the direct path; and/or
when the payload of the direct path is indicated to be low or the payload proportion of the direct path is lower than a fourth threshold, the data are transmitted by using the direct path; and/or
when the payload of the indirect path is indicated to be low or the payload proportion of the indirect path exceeds a fifth threshold, the data are transmitted by using the indirect path; and/or
when the payloads of both the direct path and the indirect path are indicated to be high or the payload proportions of the direct path and the indirect path exceed a sixth threshold and a seventh threshold respectively, the data are transmitted by using the direct path and/or the indirect path; and/or
when the payloads of both the direct path and the indirect path are indicated to be low or the payload proportions of the direct path and the indirect path are lower than an eighth threshold and a ninth threshold respectively, the data are transmitted by using the direct path and/or the indirect path.

6. The apparatus according to claim 2, wherein,
the utilization rate(s) indicate(s) a proportion of an amount of traffics transmitted via the direct path and/or the indirect path, and/or indicate(s) a ratio of amounts of traffics of the direct path and indirect path.

7. The apparatus according to claim 2, wherein in a case where the indication information comprises the utilization rate(s),
data transmission of corresponding amount of traffics is performed in the direct path and/or indirect path according to the utilization rate(s).

8. The apparatus according to claim 1,
when the data amount of the PDCP layer is greater than the first threshold, the data are transmitted by using the indirect path and/or the direct path.

9. The apparatus according to claim 8, wherein,
in a case that the data are transmitted by using the direct path, PDCP layer transmits the data to a Uu RLC (radio link control) entity.

10. The apparatus according to claim 8, wherein,
in a case that the data are transmitted by using the indirect path, PDCP layer transmits the data to an SRAP (sidelink relay adaptation protocol) entity.

11. The apparatus according to claim 2, wherein,
in a case where the indication information comprises a radio bearer or QoS flow using the direct path, data of the radio bearer or QoS flow using the direct path are transmitted by using the direct path; and/or
in a case where the indication information comprises a radio bearer or QoS flow using the indirect path, data of the radio bearer or QoS flow using the indirect path are transmitted by using the indirect path; and/or
in a case where the indication information comprises a radio bearer or QoS flow using the direct path and the indirect path, data of the radio bearer or QoS flow using the direct path and the indirect path are transmitted by using the direct path and the indirect path.

12. The apparatus according to claim 1, wherein the indication information is transmitted via an RRC message.

13. The apparatus according to claim 1, wherein,
the indication information is transmitted via the direct path and/or the indirect path.

14. The apparatus according to claim 1, wherein,
a validity of the indication information is indicated by a timer or a duration.

15. The apparatus according to claim 14, wherein,
the timer or duration is included in the indication information, or the timer or duration is configured by a network, or is predefined.

16. A multi-path processing apparatus, configured in a remote terminal equipment (remote UE), the remote terminal equipment being configured or activated with a first path and a second path, the apparatus comprising:
a transmitter configured to transmit data by using the first path and/or second path according to remaining PDBs (packet delay budgets) of sidelink data to be transmitted in a logical channel and/or the number of uplink grants or uplink resources of the first path and/or the number of SR (scheduling request) transmissions of the first path and/or the number of times of expiration of a loss timer.

17. The apparatus according to claim 16, wherein,
when the remaining PDBs of the sidelink data to be transmitted in the logical channel are lower than a tenth threshold, the data are transmitting by using the first path and/or the second path; and/or
when the number of uplink grants or uplink resources of the first path are lower than an eleventh threshold for a period of time, the data are transmitting by using the second path; and/or
when the number of SR transmissions in the first path reaches a preset threshold, the data are transmitting by using the second path; and/or
when the number of times of expiration of a loss timer of a PDCP (packet data convergence protocol) SDU (service data unit) transmitted in the first path reaches a twelfth threshold, the data are transmitting by using the second path.

18. The apparatus according to claim 17, wherein,
the period of time and/or the tenth threshold and/or the eleventh threshold and/or the twelfth threshold is/are configured by a network, or is/are predefined.

19. The apparatus according to claim 16, wherein,
the first path is a direct path, and the second path is an indirect path; or, the first path is an indirect path, and the second path is a direct path.

20. A multi-path processing apparatus, configured in a network device, the apparatus comprising:
a transmitter configured to transmit indication information to a terminal equipment, the indication information being used to indicate the terminal equipment to transmit data by using a direct path or an indirect path in the multi-path,
wherein the indication information comprises a first threshold related to a data amount of a PDCP (packet data convergence protocol) layer.
